(19) United States
(12) Patent Application Publication
(10) Pub. No.: US 2026/0278258 A1
(43) Pub. Date: Sep. 17, 2026

(54) Smart Fusion and Processing of Data Tables

(71) Applicant: TacItON LLC, Ocean, NJ (US)

(72) Inventor: Amit Arie WELLNER, Ocean, NJ (US)

(21) Appl. No.: 19/561,901

(22) Filed: Mar. 10, 2026

(30) Foreign Application Priority Data
Mar. 10, 2025 (IL) 319555

(51) Int. Cl. G06F 40/177; G06F 16/22; G06F 16/2455; G06F 40/103

(52) U.S. Cl. CPC G06F 40/177; G06F 16/2282; G06F 16/24556; G06F 40/103

(57) ABSTRACT

Systems and methods are provided for aggregating data from multiple data tables based on matching row headers. A first data table includes a plurality of first rows associated with respective row headers, and a second data table includes a plurality of second rows associated with respective row headers. A matching process is performed to compare the row headers of the first data table with the row headers of the second data table to identify one or more matching pairs of row headers, each pair including a row header corresponding to a first row in the first data table and a row header corresponding to a second row in the second data table. Based on the identified matching pairs, an aggregated data table is generated. For each matching pair, the aggregated data table includes an aggregated row comprising one or more cells from the corresponding first and second rows.

### PRIORITY

The present patent application claims priority to Israeli Patent Application No. 319555, filed Mar. 10, 2025, the contents of which are incorporated herein by reference in their entirety.

### TECHNICAL FIELD

The presently disclosed subject matter relates, in general, to the field of data tables. In particular, it relates to the field of fusion and processing of data tables.

### BACKGROUND

References considered to be relevant as background to the presently disclosed subject matter are listed below (acknowledgment of the references herein is not to be inferred as meaning that these are in any way relevant to the patentability of the presently disclosed subject matter):
U.S. Pat. No. 11,868,331;
U.S. Pat. No. 2008/059492;
U.S. Pat. No. 11,243,948;
U.S. Pat. No. 8,682,885;
U.S. Pat. No. 5,666,525;
U.S. Pat. No. 5,594,898; and
U.S. Pat. No. 11,836,445.

### GENERAL DESCRIPTION

In accordance with certain aspects of the presently disclosed subject matter, there is provided a system comprising one or more processing circuitries configured to obtain one or more computer files storing a plurality of data tables comprising a first data table and a second data table, wherein the first data table comprises a plurality of first rows associated with row headers, and the second data table comprises a plurality of second rows associated with row headers, use the one or more computer files, or data generated from the one or more computer files, to perform a matching process between the row headers of the first data table, or data informative of the row headers of the first data table, and the row headers of the second data table, or data informative of the row headers of the second data table, said matching process enabling detection of one or more matching pairs of row headers, each given matching pair of the one or more matching pairs comprising a given row header associated with a given first row of the first data table and a given row header associated with a given second row of the second data table, and use the one or more matching pairs to generate an aggregated data table in which, for each given matching pair, the aggregated data table comprises a given aggregated row comprising one or more given cells of the given first row, and one or more given cells of the given second row.

In addition to the above features, the system according to this aspect of the presently disclosed subject matter can comprise one or more of features (i) to (xxix) listed below, in any desired combination or permutation which is technically possible:
i. the system is configured to perform an aggregation of the first data table and of the second data table to generate the aggregated data table, said aggregation comprising selecting the first data table as a leading data table which dictates which row header among the row headers of the first data table is used for generating a next aggregated row of the aggregated data table, and, responsive to an event, selecting the second data table as the leading data table which dictates which row header among the row headers of the second data table is used for generating a next aggregated row of the aggregated data table;
ii. said event corresponds to detecting that a first row header of the first data table, among the row headers of the first data table that correspond to rows of the first data table that have not yet been inserted in the aggregated data table, does not match a first row header of the second data table, among the row headers of the second data table that correspond to rows of the second data table that have not yet been inserted in the aggregated data table;
iii. the data generated from the one or more computer files include at least one of a first look-up table informative of the row headers of the first data table, or a second look-up table informative of the row headers of the second data table;
iv. the system is configured to use the one or more computer files to generate a first look-up table informative of the row headers of the first data table, wherein the system is configured to use the first look-up table to process a format of one or more row headers of the first look-up table;
v. the system is configured to use the one or more computer files to generate a second look-up table informative of the row headers of the second data table, wherein the system is configured to use the second look-up table to process a format of one or more row headers of the second look-up table;
vi. the data generated from the one or more computer files comprises a first look-up table informative of the row headers of the first data table and a second look-up table informative of the row headers of the second data table, wherein the system is configured to perform an aggregation of the first data table and of the second data table to generate the aggregated data table, wherein, in said aggregation, generating of a next aggregated row depends on a selection of the first look-up table or of the second look-up table as a leading look-up table which dictates which row header among the row headers of the first data table or of the second data table is used for generating the next aggregated row;
vii. the system is configured to use the first row header of the leading look-up table to determine the row header of the next aggregated row of the aggregated data table;
viii. when the first look-up table has been selected as the leading look-up table, the system is configured to compare a first row header of the first look-up table with row headers of the second look-up table, and responsive to detecting that the first row header of the first look-up table matches a certain row header of the second look-up table, generate a command for generating an aggregated row including one or more cells of a first row associated with the first row header, and one or more cells of a second row associated with the certain row header;
ix. when the first look-up table has been selected as the leading look-up table, the system is configured to compare a first row header of the first look-up table with a first row header of the second look-up table, responsive to detecting that the first row header of the first look-up table does not match the first row header of the second look-up table, generate a command for selecting the second look-up table as the leading look-up table;
x. the system is configured to detect one or more non-matching row headers of the first data table that do not match any row headers of the second data table, and use the one or more non-matching row headers to generate one or more aggregated rows, wherein each given aggregated row of said one or more aggregated rows comprises one or more cells of a given row associated with a given non-matching row header of the one or more non-matching row headers of the first data table, followed by, in a left-to-right direction, one or more empty cells, wherein a number of the one or more empty cells depends on a number of columns of the second data table;
xi. the system is configured to detect one or more non-matching row headers of the second data table that do not match any row headers of the first data table, and use the one or more non-matching row headers to generate one or more aggregated rows, wherein each given aggregated row of said one or more aggregated rows comprises one or more empty cells, followed by, in a left-to-right direction, one or more cells of a given row associated with a given non-matching row header of the one or more non-matching row headers of the second data table, and wherein a number of the one or more empty cells depends on a number of columns of the first data table;
xii. the system is configured to extract, from the plurality of data tables, one or more pairs of matching data tables, wherein a given pair comprises the first data table and the second data table;
xiii. the system is configured to determine, from the plurality of data tables, one or more pairs of matching data tables, wherein at least one pair of two matching data tables is determined based on a comparison of row headers between the two data tables;
xiv. the system is configured to determine, from the plurality of data tables, one or more pairs of matching data tables, wherein at least one pair of two matching data tables is determined based on a comparison of names between the two data tables;
xv. the system is configured to determine a matching threshold based on at least one of a number of row headers of a data table of the plurality of data tables and a number of row headers of another data table of the plurality of data tables, and determine whether said data table and said another data table match, based on a comparison between the row headers of said data table and row headers of said another data table, and said matching threshold;
xvi. the system is configured to, for a given data table, determine whether said given data table match at least one other data table of the plurality of data tables, based on a comparison between the row headers of said data table and row headers of said other data table, wherein said comparison uses a matching threshold which is based on at least one of a number of row headers of the given data table and a number of row headers of said other data table, and responsive to a detection that said given data table does not match any other data table of the plurality of data tables, determine whether said given data table matches at least one other data table of the plurality of data tables based on a comparison of names between the given data table and said other data table;
xvii. the system is configured to detect a type of data stored in one or more cells of the aggregated data table, and adapt metadata of the one or more cells to this type;
xviii. the system is configured to detect a first column and a second column of the aggregated data table which match according to a criterion, and remove the second column;
xix. the match is detected when: (1) a column header of the first column matches a column header of the second column, and (2) for any given row which does not correspond to a row of column headers, a cell of the first column located in this given row matches a cell of the second column located in this given row, or, one of the two cells is empty;
xx. for any given row of the aggregated data table in which a given cell of the first column is empty, the system is configured to fill this given cell of the first column with data of a cell that was present in this given row in the second column;
xxi. for any given row of the aggregated data table in which a given cell of the first column contains data, the system is configured to keep the data of this given cell of the first column;
xxii. the system is configured to detect a first row and a second row of the aggregated data table which match according to a criterion, and remove the second row;
xxiii. for any given column of the aggregated data table in which a given cell of the first row is empty, the system is configured to fill this given cell of the first row with data of a cell that was present in this given column in the second row;
xxiv. for any given column of the aggregated data table in which a given cell of the first row contains data, the system is configured to keep this data in the given cell of the first row;
xxv. the aggregated data table comprises a first cell comprising one or more characters informative of a certain type of data and a second cell comprising data, wherein the system is configured to fuse the first cell and the second cell into a cell which includes the data of the second cell, and is assigned with metadata determined based on the content of the first cell;
xxvi. the system is configured to remove at least one of trailing white space or leading white space in one or more cells of the aggregated data table;
xxvii. the first data table comprises a plurality of cells arranged along first rows and first columns, and row headers, wherein the second data table comprises a plurality of cells arranged along second rows and second columns, and row headers, wherein the system is configured to generate an aggregated data table in which the cells of the first data table are arranged as they were arranged in the first data table;
xxviii. the system enables, in the aggregated data tables, duplicate rows or duplicate columns; and
xxix. the data informative of the row headers of the first data table comprise the row headers of the first data table after a processing of a format of at least some of the row headers of the first data table and the data informative of the row headers of the second data table comprise the row headers of the second data table after a processing of a format of at least some of the row headers of the second data table.

In addition to the above features, the system according to this aspect of the presently disclosed subject matter can comprise one or more of features (xxx) to (xlvi), in any desired combination or permutation which is technically possible:

In accordance with other aspects of the presently disclosed subject matter, there is provided a system comprising one or more processing circuitries configured to obtain one or more computer files storing a plurality of data tables comprising a first data table and a second data table, wherein the first data table comprises a plurality of cells arranged along first rows associated with row headers and first columns, and wherein the second data table comprises a plurality of cells arranged along second rows associated with row headers and second columns, use the one or more computer files, or data generated from the one or more computer files, to generate an aggregated data table in which the cells of the first data table are arranged as they were arranged in the first data table, wherein, for each row header of the first data table that matches another row header of the second data table, the aggregated data table comprises an aggregated row comprising cells of a row associated with said row header in the first data table and cells of a row associated with said another row header in the second data table.

In addition to the above features, the system according to this aspect of the presently disclosed subject matter can comprise one or more of features (xxx) to (xl) listed below, in any desired combination or permutation which is technically possible:
xxx. the system is configured to generate the aggregated data table in which the first rows and the first columns of the first data table are arranged as they were arranged in the first data table;

xxxi. the system is configured to perform a matching process between the row headers of the first data table and the row headers of the second data table, enabling detection of one or more matching pairs of row headers, each given matching pair of the one or more matching pairs comprising a given row header associated with a given first row of the first data table and a given row header associated with a given second row of the second data table, and use the one or more matching pairs to generate the aggregated data table in which, for each given matching pair, the aggregated data table comprises a given aggregated row comprising one or more given cells of the given first row, and one or more given cells of the given second row;
xxxii. the system is configured to detect one or more non-matching row headers of the first data table that do not match any row headers of the second data table, and use the one or more non-matching row headers to generate one or more aggregated rows, wherein each given aggregated row of said one or more aggregated rows comprises one or more cells of a given row associated with a given non-matching row header of the one or more non-matching row headers of the first data table, and one or more empty cells, wherein a number of the one or more empty cells depends on a number of columns of the second data table;
xxxiii. the system configured to detect one or more non-matching row headers of the second data table that do not match any row headers of the first data table, and use the one or more non-matching row headers to generate one or more aggregated rows, wherein each given aggregated row of said one or more aggregated rows comprises one or more empty cells and one or more cells of a given row associated with a given non-matching row header of the one or more non-matching row headers of the second data table, wherein a number of the one or more empty cells depends on a number of columns of the first data table;
xxxiv. the system is configured to detect one or more non-matching row headers of the first data table that do not match any row headers of the second data table, and use the one or more non-matching row headers to generate one or more aggregated rows, wherein each given aggregated row of said one or more aggregated rows comprises one or more cells of a given row associated with a given non-matching row header of the one or more non-matching row headers of the first data table, followed by, in a left-to-right direction, one or more empty cells, wherein a number of the one or more empty cells depends on a number of columns of the second data table;
xxxv. the system is configured to detect one or more non-matching row headers of the second data table that do not match any row headers of the first data table, and use the one or more non-matching row headers to generate one or more aggregated rows, wherein each given aggregated row of said one or more aggregated rows comprises one or more empty cells and one or more cells of a given row associated with a given non-matching row header of the one or more non-matching row headers of the second data table, wherein a number of the one or more empty cells depends on a number of columns of the first data table;
xxxvi. the system is configured to detect one or more non-matching row headers of the first data table that do not match any row headers of the second data table, and use the one or more non-matching row headers to generate one or more aggregated rows, wherein each given aggregated row of said one or more aggregated rows comprises one or more cells of a given row associated with a given non-matching row header of the one or more non-matching row headers of the first data table, followed by, in a left-to-right direction, one or more empty cells, wherein a number of the one or more empty cells depends on a number of columns of the second data table;
xxxvii. the system is configured to detect one or more non-matching row headers of the second data table that do not match any row headers of the first data table, and use the one or more non-matching row headers to generate one or more aggregated rows, wherein each given aggregated row of said one or more aggregated rows comprises one or more empty cells, followed by, in a left-to-right direction, one or more cells of a given row associated with a given non-matching row header of the one or more non-matching row headers of the second data table, and wherein a number of the one or more empty cells depends on a number of columns of the first data table;
xxxviii. the system is configured to generate a first look-up table informative of row headers of the first data table, generate a second look-up table informative of row headers of the second data table, and use the first look-up table and the second look-up table to perform an aggregation of the first data table and the second data table enabling generating the aggregated data table;
xxxix. the system is configured to use, during at least part of the aggregation, the first look-up table as a leading look-up table which dictates which row header among the row headers of the first data table is to be used for generating a next aggregated row of the aggregated data table in said aggregation; and
xl. once each respective row header of the first look-up table has been used to generate a respective aggregated row of the aggregated data table, the system is configured to select the second look-up table as the leading look-up table which dictates which row header among the row headers of the second data table is to be used for generating a next aggregated row of the aggregated data table in said aggregation.

In addition to the above features, the system according to this aspect of the presently disclosed subject matter can comprise one or more of features (i) to (xxix) and (xli) to (xlvi), in any desired combination or permutation which is technically possible.

In accordance with other aspects of the presently disclosed subject matter, there is provided a system comprising one or more processing circuitries configured to obtain one or more computer files storing a plurality of data tables comprising a first data table and a second data table, wherein the first data table comprises a plurality of first columns associated with column headers, and the second data table comprises a plurality of second columns associated with column headers, use the one or more computer files, or data generated from the one or more computer files, to perform an aggregation of the first data table and of the second data table into an aggregated data table comprising aggregated columns, wherein said aggregation comprises selecting the first data table, or data informative thereof, as a leading data table which dictates which column header among the column headers of the first data table is used for generating a next aggregated column of the aggregated data table in said aggregation, and, responsive to an event, selecting the second data table as the leading data table which dictates which column header among the column headers of the second data table is used for generating the next aggregated column of the aggregated data table in said aggregation.

In addition to the above features, the system according to this aspect of the presently disclosed subject matter can comprise one or more of features (xli) to (xlvi) listed below, in any desired combination or permutation which is technically possible:
xli. said event corresponds to detecting that a first column header of the first data table, among the column headers of the first data table that correspond to columns that have not yet been inserted in the aggregated data table, does not match a first column header of the second data table, among the column headers of the second data table that correspond to columns that have not yet been inserted in the aggregated data table;
xlii. for a column header of a column of the first data table that has been identified as matching a column header of a column of the second data table, the aggregated data table comprises an aggregated column comprising cells of said column of the first data table and cells of said column of said column of the second data table;
xliii. for a column header of a column of the first data table that has been identified as not matching any column header of the second data table, the aggregated data table comprises an aggregated column comprising cells of said column of the first data table followed by, in a top-to-down direction, empty cells;
xliv. for a column header of a column of the second data table that has been identified as not matching any column header of the first data table, the aggregated data table comprises an aggregated column comprising empty cells followed by, in a top-to-down direction, cells of said column of the second data table;
xlv. the data generated from the one or more computer files comprises a first look-up table informative of the row headers of the first data table and a second look-up table informative of the row headers of the second data table, wherein the system is configured to perform an aggregation of the first data table and of the second data table to generate the aggregated data table, wherein, in said aggregation, generating of a next aggregated column depends on a selection of the first look-up table or of the second look-up table as a leading look-up table which dictates which column header among the column headers of the first data table or of the second data table is used for generating the next aggregated column; and
xlvi. when the first look-up table has been selected as the leading look-up table, the system is configured to compare a first column header of the first look-up table with a first column header of the second look-up table, and responsive to detecting that the first column header of the first look-up table does not match the first column header of the second look-up table, generate a command for selecting the second look-up table as the leading look-up table.

In addition to the above features, the system according to this aspect of the presently disclosed subject matter can comprise one or more of features (i) to (xl), in any desired combination or permutation which is technically possible.

In accordance with other aspects of the presently disclosed subject matter, there is provided a computer-implemented method comprising obtaining one or more computer files storing a plurality of data tables comprising a first data table and a second data table, wherein the first data table comprises a plurality of first rows associated with row headers, and the second data table comprises a plurality of second rows associated with row headers, using the one or more computer files, or data generated from the one or more computer files, to perform a matching process between the row headers of the first data table, or data informative of the row headers of the first data table, and the row headers of the second data table, or data informative of the row headers of the second data table, said matching process enabling detection of one or more matching pairs of row headers, each given matching pair of the one or more matching pairs comprising a given row header associated with a given first row of the first data table and a given row header associated with a given second row of the second data table, and using the one or more matching pairs to generate an aggregated data table in which, for each given matching pair, the aggregated data table comprises a given aggregated row comprising one or more given cells of the given first row, and one or more given cells of the given second row.

In addition to the above features, the method according to this aspect of the presently disclosed subject matter can comprise one or more of features (i) to (xlvi), in any desired combination or permutation which is technically possible.

In accordance with other aspects of the presently disclosed subject matter, there is provided a computer-implemented method comprising obtaining one or more computer files storing a plurality of data tables comprising a first data table and a second data table, wherein the first data table comprises a plurality of cells arranged along first rows associated with row headers and first columns, and wherein the second data table comprises a plurality of cells arranged along second rows associated with row headers and second columns, using the one or more of computer files, or data generated from the one or more computer files, to generate an aggregated data table in which the cells of the first data table are arranged as they were arranged in the first data table, wherein, for each row header of the first data table that matches another row header of the second data table, the aggregated data table comprises an aggregated row comprising cells of a row associated with said row header in the first data table and cells of a row associated with said another row header in the second data table.

In addition to the above features, the method according to this aspect of the presently disclosed subject matter can comprise one or more of features (i) to (xlvi), in any desired combination or permutation which is technically possible.

In accordance with other aspects of the presently disclosed subject matter, there is provided a computer-implemented method comprising obtaining one or more computer files storing a plurality of data tables comprising a first data table and a second data table, wherein the first data table comprises a plurality of first columns associated with column headers, and the second data table comprises a plurality of second columns associated with column headers, using the one or more of computer files, or data generated from the one or more computer files, to perform an aggregation of the first data table and of the second data table into an aggregated data table comprising aggregated columns, wherein said aggregation comprises selecting the first data table, or data informative thereof, as a leading data table which dictates which column header among the column headers of the first data table is used for generating a next aggregated column of the aggregated data table in said aggregation, and, responsive to an event, selecting the second data table as the leading data table which dictates which column header among the column headers of the second data table is used for generating the next aggregated column of the aggregated data table in said aggregation.

In addition to the above features, the method according to this aspect of the presently disclosed subject matter can comprise one or more of features (i) to (xlvi), in any desired combination or permutation which is technically possible.

In accordance with other aspects of the presently disclosed subject matter, there is provided a non-transitory computer readable medium comprising instructions that, when executed by one or more computers, cause the one or more computers to obtain one or more computer files storing a plurality of data tables comprising a first data table and a second data table, wherein the first data table comprises a plurality of first rows associated with row headers, and the second data table comprises a plurality of second rows associated with row headers, use the one or more computer files, or data generated from the one or more computer files, to perform a matching process between the row headers of the first data table, or data informative of the row headers of the first data table, and the row headers of the second data table, or data informative of the row headers of the second data table, said matching process enabling detection of one or more matching pairs of row headers, each given matching pair of the one or more matching pairs comprising a given row header associated with a given first row of the first data table and a given row header associated with a given second row of the second data table, and use the one or more matching pairs to generate an aggregated data table in which, for each given matching pair, the aggregated data table comprises a given aggregated row comprising one or more given cells of the given first row, and one or more given cells of the given second row.

In addition to the above features, the non-transitory computer readable medium according to this aspect of the presently disclosed subject matter can comprise one or more of features (i) to (xlvi), in any desired combination or permutation which is technically possible.

In accordance with other aspects of the presently disclosed subject matter, there is provided a non-transitory computer readable medium comprising instructions that, when executed by one or more computers, cause the one or more computers to obtain one or more computer files storing a plurality of data tables comprising a first data table and a second data table, wherein the first data table comprises a plurality of cells arranged along first rows associated with row headers and first columns, and wherein the second data table comprises a plurality of cells arranged along second rows associated with row headers and second columns, use the one or more computer files, or data generated from the one or more computer files, to generate an aggregated data table in which the cells of the first data table are arranged as they were arranged in the first data table, wherein, for each row header of the first data table that matches another row header of the second data table, the aggregated data table comprises an aggregated row comprising cells of a row associated with said row header in the first data table and cells of a row associated with said another row header in the second data table.

In addition to the above features, the non-transitory computer readable medium according to this aspect of the presently disclosed subject matter can comprise one or more of features (i) to (xlvi), in any desired combination or permutation which is technically possible.

In accordance with other aspects of the presently disclosed subject matter, there is provided a non-transitory computer readable medium comprising instructions that, when executed by one or more computers, cause the one or more computers to obtain one or more computer files storing a plurality of data tables comprising a first data table and a second data table, wherein the first data table comprises a plurality of first columns associated with column headers, and the second data table comprises a plurality of second columns associated with column headers, use the one or more computer files, or data generated from the one or more computer files, to perform an aggregation of the first data table and of the second data table into an aggregated data table comprising aggregated columns, wherein said aggregation comprises selecting the first data table, or data informative thereof, as a leading data table which dictates which column header among the column headers of the first data table is used for generating a next aggregated column of the aggregated data table in said aggregation, and, responsive to an event, selecting the second data table as the leading data table which dictates which column header among the column headers of the second data table is used for generating the next aggregated column of the aggregated data table in said aggregation.

In addition to the above features, the non-transitory computer readable medium according to this aspect of the presently disclosed subject matter can comprise one or more of features (i) to (xlvi), in any desired combination or permutation which is technically possible.

The proposed solution provides various technical advantages. At least some of them are listed hereinafter.

The proposed solution proposes an automatic and smart solution enabling identification and fusion of similar data tables.

According to some examples, the proposed solution enables efficient and automatic assembling of data tables from multiple files with different data schemas, without requiring prior knowledge of the table schema or the structure of the content. The solution is therefore flexible and user-friendly.

According to some examples, the proposed solution proposes a smart cleaning and processing of the data tables.

According to some examples, the proposed solution preserves, as much as possible, the structure of the data during the fusion process. In particular, in some examples, it keeps the order of the rows (or columns) of at least one of the data tables during the fusion process.

According to some examples, the proposed solution enables the user to readily visualize mismatching rows between data tables that are aggregated into an aggregated data table.

According to some examples, the proposed solution reduces the computation resources required to aggregate data tables.

According to some examples, the proposed solution takes into account configuration parameters provided by a user in order to perform the fusion process.

According to some examples, the proposed solution does not rely on hash-based matching, but instead uses a configuration-based approach to identify matching rows or column headers.

According to some examples, the proposed solution proposes a fusion approach which relies on the row headers rather than on the matching of column headers.

According to some examples, the proposed solution proposes various output options.

According to some examples, the proposed solution is operative to handle data files containing data tables, and is therefore not limited to relational database management systems.

According to some examples, the proposed solution improves data analysis and management in various fields, making it easier to extract insights and value from large datasets.

According to some examples, the proposed solution provides a technical solution to the problem of efficiently matching and combining data from multiple sources. It is able to handle large data sets.

According to some examples, the proposed solution uses lookup tables which are informative of the row headers of the respective data tables, and of the location of the row headers. This enables fast and efficient matching of the row headers, as well as fast and efficient generation of aggregated data tables. It also enables scaling of large datasets.

According to some examples, the proposed solution is operative to fuse large amounts of data from multiple sources.

According to some examples, the proposed solution provides a systematic and automated approach to matching and combining data, which reduces the likelihood of human error and provides a more consistent and accurate result.

According to some examples, the proposed solution provides data enhancements and a valuable way to collect data in a mindful way.

According to some examples, the proposed solution can be integrated with other technical systems, such as Excel.

According to some examples, the proposed solution enables fusing the data tables while enabling improved visual identification of the row headers or column headers for which there is a mismatch between the data tables.

According to some examples, the proposed solution enables a better combination of the data between the data tables.

According to some examples, the proposed solution enables maintaining a balance between the data from the data tables, by preventing one table's data from dominating the result.

According to some examples, the proposed solution reduces the bias towards one data table's data.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1A illustrates a generalized block diagram of a system in accordance with certain examples of the presently disclosed subject matter.

FIG. 1B illustrates a non-limitative example of the computer files storing data tables.

FIG. 1C illustrates a non-limitative example of a data table.

FIG. 2 illustrates a generalized flow-chart of a method of fusing data tables.

FIGS. 3A to 3C illustrate non-limitative examples of identifying matching data tables.

FIG. 4A illustrates a generalized flow-chart of a method enabling identifying matching data tables.

FIG. 4B illustrates a generalized flow-chart of a method enabling identifying matching data tables.

FIG. 5 illustrates a non-limitative example of the method of FIG. 4B.

FIG. 6A illustrates a generalized flow-chart of a method enabling determining whether two data tables match.

FIG. 6B illustrates a generalized flow-chart of a method enabling identifying matching data tables within a set of data tables.

FIG. 7 illustrates a non-limitative example of the methods of FIGS. 6A and 6B.

FIG. 8 illustrates a generalized flow-chart of a method enabling identifying matching data tables.

FIG. 9 illustrates a generalized flow-chart of a method enabling determining and using a variable matching threshold, to identify matching data tables.

FIG. 10A illustrates a non-limitative example of the method of FIG. 9.

FIG. 10B illustrates a generalized flow-chart of a method enabling identifying matching data tables.

FIG. 10C illustrates a generalized flow-chart of a method enabling identifying matching data tables.

FIG. 10D illustrates a non-limitative example of the method of FIG. 10C.

FIG. 11 illustrates a generalized flow-chart of a method of fusing data tables.

FIG. 12 illustrates a non-limitative example of the method of FIG. 11.

FIG. 13A illustrates a generalized flow-chart of a method of fusing data tables.

FIGS. 13B to 13D illustrate a non-limitative example of the method of FIG. 13A.

FIG. 13E illustrates a generalized flow-chart of a method of fusing data tables.

FIG. 13F illustrates a non-limitative example of the method of FIG. 13E.

FIG. 14A illustrates a generalized flow-chart of a method of fusing data tables.

FIG. 14B illustrates a non-limitative example of the method of FIG. 14A.

FIG. 15 illustrates a generalized flow-chart of a method of fusing data tables.

FIG. 16A illustrates a non-limitative example of the method of FIG. 15.

FIG. 16B illustrates a generalized flow-chart of a method of fusing data tables.

FIG. 17 illustrates a generalized flow-chart of a method of processing the aggregated data tables.

FIG. 18 illustrates a generalized flow-chart of a method of adapting the metadata of cells.

FIG. 19 illustrates a generalized flow-chart of a method of fusing matching columns.

FIG. 20 illustrates a non-limitative example of the method of FIG. 19.

FIG. 21 illustrates a generalized flow-chart of a method of fusing matching rows.

FIG. 22 illustrates a non-limitative example of the method of FIG. 21.

FIG. 23 illustrates a generalized flow-chart of a method of fusing cells.

FIG. 24 illustrates a non-limitative example of the method of FIG. 23.

FIG. 25 illustrates a non-limitative example of removing leading white spaces.

FIG. 26 illustrates a non-limitative example of removing trailing white spaces.

FIG. 27 illustrates a generalized flow-chart of a method of outputting the aggregated data table(s).

FIGS. 28 and 29 illustrate non-limitative examples of methods described hereinafter.

### DETAILED DESCRIPTION OF EMBODIMENTS

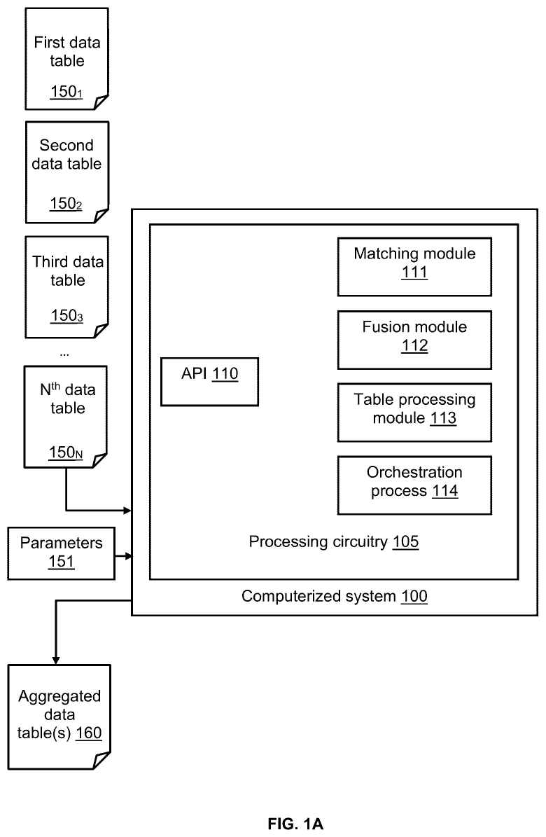

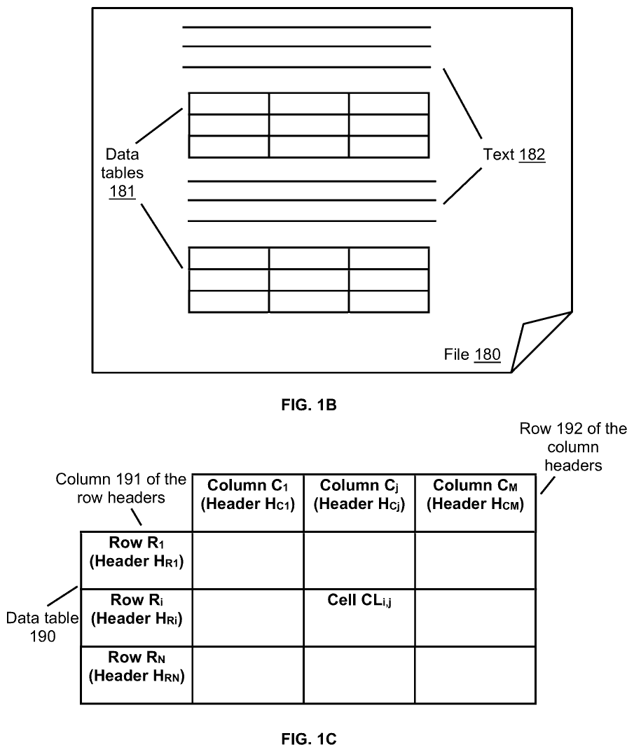

Attention is drawn to FIG. 1A, which describes a computerized system 100, usable to perform one or more of the methods described hereinafter. In some examples, the computerized system 100 can correspond or include one or more servers and/or one or more computers and/or one or more clouds. As explained hereinafter, the computerized system 100 is operative to process data tables. In particular, it can identify matching data tables and fuse them into aggregated data table(s) in a smart and efficient way. The computerized system 100 can perform various additional processing operations enabling improving the arrangement and/or the content of the data tables.

The computerized system 100 includes at least one processing circuitry 105 (or a plurality of processing circuitries 105). The processing circuitry 105 can implement various functional modules. In some examples, the processing circuitry 105 implements an API 110 (Application Programming Interface). The API 110 can be associated with a user interface enabling a third party (e.g., a user) to provide input data.

The processing circuitry 105 can implement additional modules, such as:
a matching module 111, enabling identifying matching/similar data tables;
a fusion module 112, enabling fusing data tables;
a table processing module 113, enabling processing data tables;
an orchestration module 114, enabling orchestrating the data to be output by the computerized system 100.

The API 110 and the various modules 111, 112, 113, and 114 can include a list of instructions stored in non-transitory computer readable medium, the instructions being such that, when executed by the processing circuitry 105, enable executing one or more of the operations described hereinafter.

The computerized system 100 is configured to receive input data. The input data can include a plurality of data tables (see first data table 150₁, second data table 150₂, third data table 150₃, . . . , N^{th} data table 150_{N}, with N≥2). In some examples, one or more of the data tables can be stored in a file including data tables and/or additional data (which are of a different type, such as images, text, etc.). A non-limitative example is illustrated in FIG. 1B, in which a file 180 includes two data tables 181 and text 182 which is not stored in a data table.

The computerized system 100 can further receive parameters 151 (also called configuration parameters). The parameters 151 can define various parameters of the operations performed by the computerized system 100 (e.g., matching of tables, fusion of tables, processing of tables, etc.).

The input data (data tables, parameters) can be transmitted/uploaded to the computerized system 100 using the API 110. The input data can be transmitted/uploaded by a user and/or via any adapted computerized device in communication with the computerized system 100, such as a computer, a smartphone, a server, a cloud, etc.

The computerized system 100 is configured to output one or more aggregated data table(s) 160, based on a smart aggregation of data tables received as input. Note that each data table of the input data which has not been aggregated with another data table of the input data can be also output, possibly after one or more processing operations, enabling improving the arrangement and/or the content of the data.

FIG. 1C depicts a non-limitative example of a data table 190. The data table 190 includes one or more rows (rows R₁ to R_{N}) and one or more columns (columns C₁ to C_{M}), with at least one of N or M equal to or larger than two (note that in many cases both N and M are equal to or larger than two). In each cell CLi, j of the data table (located at an intersection of a row (Rᵢ) and a column (Cⱼ)), data is stored in the data table 190. The data stored in the data table generally include characters such as text, numbers, symbols, etc.

In some examples, each respective row (R₁, . . . , Rᵢ, . . . , R_{N}) of the data table 190 is associated with a respective row header (HR₁, . . . , HRᵢ, . . . , HR_{N}). A row header is, in general, the column 191 at the edge of the table (left edge for sinistrodextral language, such as English, and right edge for dextrosinistral language, such as Hebrew) that identifies each row within the table. It provides a label for the row. It enables establishing a relationship between the various data of the same row. Each respective row header can be viewed as a title for each row. The row header can include e.g. string(s) and/or number(s) and/or symbol(s). In some examples, each respective row header describes the content of the data stored in each respective row. This is not limitative and the row header can be arbitrary data. For example, in an Excel file, the row headers can correspond to the numbers of the rows.

In some examples, each respective column (C₁, . . . , Cᵢ, . . . , C_{N}) of the data table 190 is associated with a respective column header (HC₁, . . . , HCᵢ, . . . , HC_{N}). A column header is, in general, the row 192 at the top of the table that identifies each column within the table. It provides a label for the column. It enables establishing a relationship between the various data of the same column. Each respective column header can be viewed as a title for each column. The column header can include e.g. string(s) and/or number(s) and/or symbol(s). In some examples, each respective column header describes the content of the data stored in each respective column. This is not limitative and the column header can be arbitrary data. For example, in an Excel file, the column headers can correspond to the numbers of the columns.

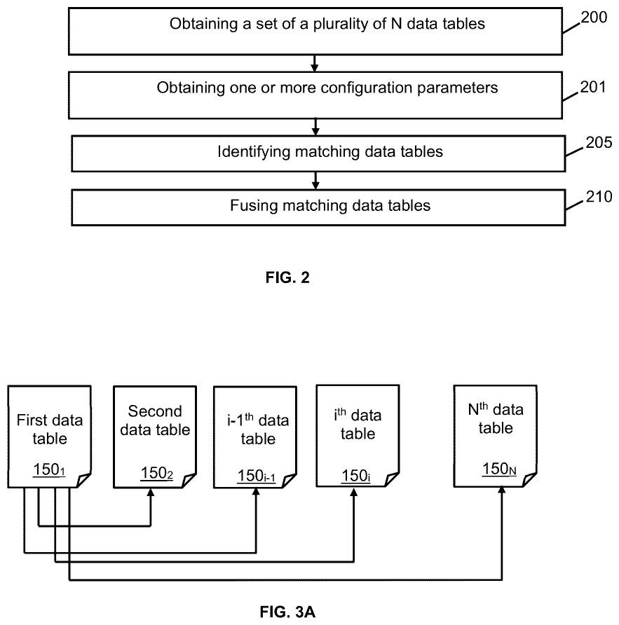

Attention is now drawn to FIG. 2.

The method of FIG. 2 includes obtaining (operation 200) a set of a plurality of N data tables (see e.g., first data table 150₁, second data table 150₂, . . . , N^{th} data table 150_{N}), with N≥2. As mentioned above, the data tables can be uploaded to the computerized system 100, using e.g. the API 110. The data tables can be uploaded as part of file(s) uploaded using the API. In some examples, a file including multiple data tables can be uploaded. In this case, the different data tables can be extracted from the file by the computerized system 100. As explained hereinafter, the method of FIG. 2 (or other methods described hereinafter) uses the one or more computer files, or data generated from the one or more computer files (this can include e.g., the data tables extracted from the files, or data generated from the data tables, such as data informative of the headers of the data tables including e.g., look-up tables informative of the headers, or any other relevant data extracted from the computer files), to perform various operations, such as cleaning of the format of the headers, identifying matching data tables, fusing matching data tables, etc.

The method of FIG. 2 can also include obtaining (operation 201) one or more configuration parameters. The configuration parameters include preferences (also called settings) of the user for performing one or more of the various operations described hereinafter. The API 110 can transfer the set of data tables and the configuration parameters to the matching module 111.

The method of FIG. 2 further includes (operation 205) identifying, within the set of data tables, matching (also called similar) data tables. Operation 205 can be performed by the matching module 111. In particular, the method of FIG. 2 can include identifying pairs of matching data tables.

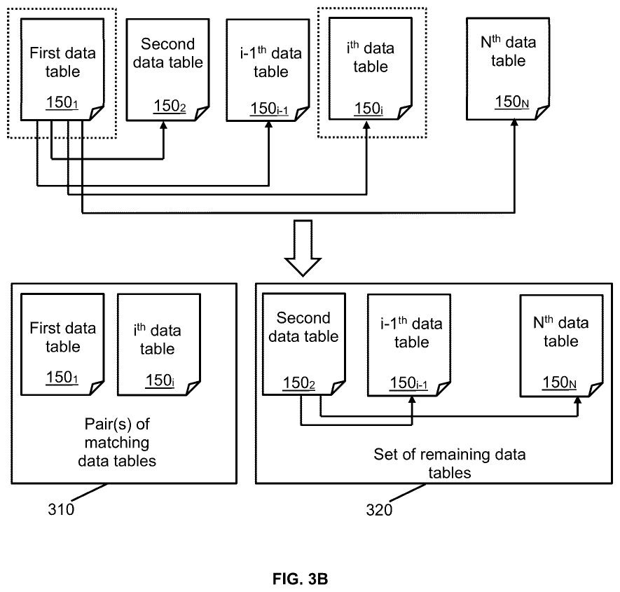

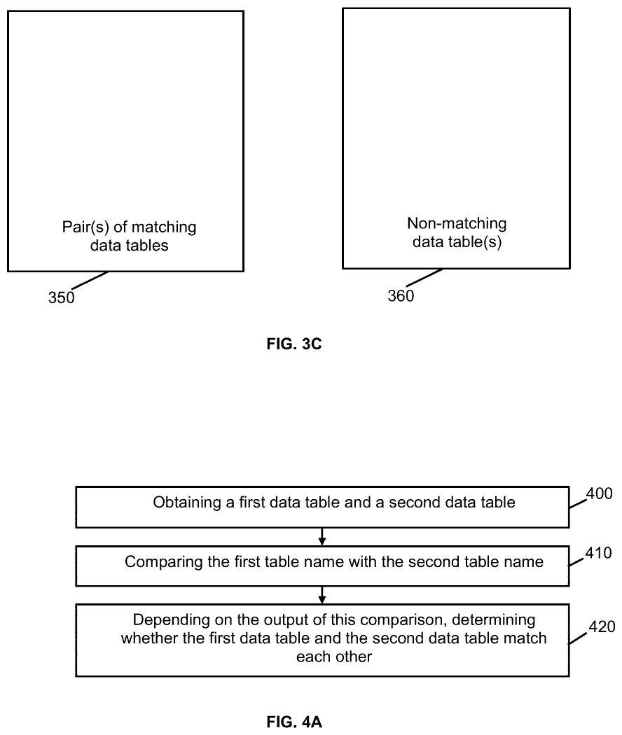

A non-limitative example of this matching process is described in FIGS. 3A and 3B. Assume that a set of N data tables have been extracted from the files uploaded to the computerized system 100. A first data table of the set is compared to each of the other N-1 data tables. This is visible in FIG. 3A, which illustrates a comparison between the first data table 150₁ and the second table 150₂, a comparison between the first data table 150₁ and the i-1^{th} data table 150ᵢ₋₁, a comparison between the first data table 150₁ and the i^{th} data table 150ᵢ, and a comparison between the first data table 150₁ and the N^{th} data table 150_{N}.

As visible in FIG. 3B, the given data table for which the comparison indicates the highest matching and/or for which the matching is above a matching threshold, is identified as matching the first data table 150₁. The pair including the first data table 150₁ and the given data table is extracted from the set of data tables (see reference 310 in FIG. 3B). In the example of FIG. 3B, the pair corresponds to the first data table and the i^{th} data table. Therefore, this pair is removed from the set,, and remains in the set of all other data tables, except the first data table and the it data table. The process is then repeated with the next data table (second data table 150₂), which is then compared to all other data tables that remain in the set (as visible in reference 320 in FIG. 3B).

At the end of the process, one or more pairs of matching data tables have been identified (see reference 350 in FIG. 3C). Note that it can occur that one or more given data tables do not match with any of the other data tables of the set. In this case, this/these given data table(s) is/are identified as non-matching data table(s) and is/are not associated with any of the other data tables. The one or more given data tables are stored as non-matching tables (see reference 360 in FIG. 3C). In some cases, it can occur that each data table has been classified within a certain pair of matching data table. In this scenario, there is no non-matching data table. In some cases, it can occur that none of the data tables has been identified as a matching data table. In this scenario, all the data tables are classified as non-matching data tables.

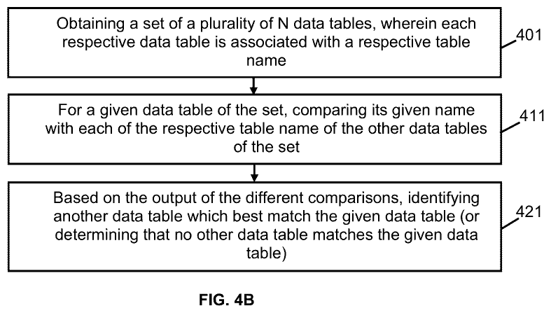

FIGS. 4A and 4B illustrate methods enabling determining matching between data tables.

The method of FIG. 4A includes obtaining (operation 400) a first data table and a second data table. It is intended to determine whether the first data table and the second data table match. Note that the first data table and the second data table may have been extracted from a set of a plurality of data tables, as explained with reference to FIGS. 3A and 3B.

The first data table is associated with a first table name. The first table name can correspond to the name of the file in which the first data table is stored. Alternatively, the first table name can correspond to the name of a sheet (e.g., Excel sheet) in which the first data table is stored.

The second data table is associated with a second table name, corresponding to the name of the file in which the second data table is stored. The second table name can correspond to the name of the file in which the second data table is stored. Alternatively, the second table name can correspond to the name of a sheet (e.g., Excel sheet) in which the second data table is stored.

The method of FIG. 4A comprises comparing the first table name with the second table name (operation 410). Depending on the output of this comparison, it can be decided whether the first data table and the second data table match (operation 420). In some examples, if the output of the comparison complies with a matching criterion, it can be decided that the first data table and the second data table match. In some examples, matching between the data tables is detected according to the matching criterion, when the number of characters of the first table name that match the characters of the second table name is above a threshold (which can be expressed e.g., as an absolute value or as a relative value, such as a percentage).

In some examples (see FIG. 4B), assume that a set of N data tables has been obtained, wherein each respective data table is associated with a respective table name (operation 401). In this case, the method of FIG. 4B can include (operation 411) comparing the first table name with each of the respective table names of the other respective table names. Each comparison outputs a score. The comparison which outputted the highest score can be used to identify the data table of the set which best matches the first data table (operation 421). Note that this is possible to require that the highest score be also above a certain threshold in order to determine matching. This ensures that there is an actual match between the data tables. Indeed, it can occur that the highest score is in fact very low and does not correspond to an actual match. If no matching data table has been identified, this indicates that the given data table does not match any other data tables of the set. The given data table can be classified as part of the non-matching data tables. Operation 411 and 421 can be repeated for the different data tables of the set.

In some examples, the comparison between the table names disregards leading and trailing white spaces. For example, the title “Table 1” (with a leading space) and the title “Table 1” (without any leading space) are considered as matching each other. The same applies to trailing white space (space at the end of the title).

In some examples, the comparison between the table names is case insensitive. For example, the title “table 1” and the title “TABLE 1” are considered as matching.

In some examples, the table names may be pre-processed in order to remove the leading and trailing white spaces, and to convert all capital letters into lowercase letters (thereby enabling a comparison which is insensitive to trailing and leading white spaces, and to capital letters).

In some examples, the comparison between the table names uses a string matching algorithm, such as (but not limited to), a Fuzzy matching algorithm.

Note that the decision of identifying matching data tables based on the respective file names can be based on the configuration parameter(s) which indicate that this criterion has to be used. As mentioned above, this can correspond to a user's preference.

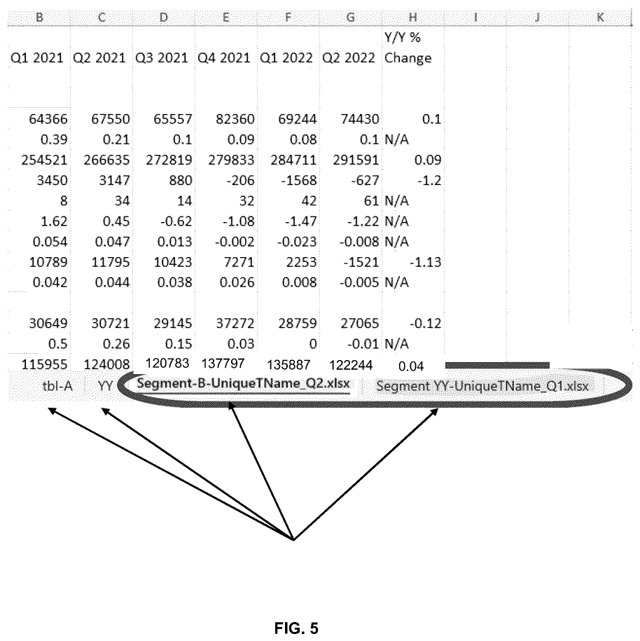

A non-limitative example of the methods of FIGS. 4A and 4B is depicted in FIG. 5. Four data tables are present in a file, with the following respective table names: “tbl-A”, “YY”, “Segment-B-UniqueTName_Q2.xlsx” and “Segment YY-UniqueTName_Q1.xlsx”. The method of FIG. 4A or of FIG. 4B enables identifying a match that complies with the matching threshold between the data table entitled “Segment-B-UniqueTName_Q2.xlsx” and the data table entitled “Segment YY-UniqueTName_Q1.xlsx”.

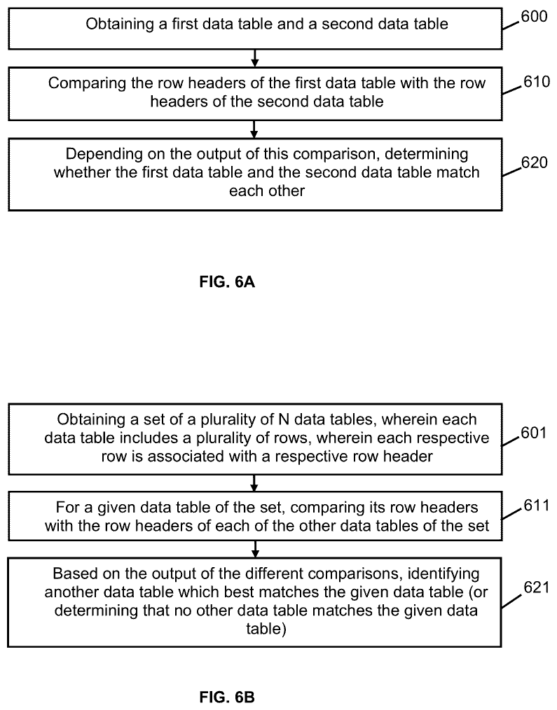

FIGS. 6A and 6B illustrate other methods enabling determining matching between data tables.

The method of FIG. 6A includes obtaining (operation 600) a first data table and a second data table. It is intended to determine whether the first data table and the second data table match. Note that the first data table and the second data table may have been extracted from a set of a plurality of data tables, as explained with reference to FIGS. 3A and 3B.

The first data table includes a plurality of first rows. Each respective first row is associated with a respective row header. The second data table includes a plurality of second rows. Each respective second row is associated with a respective row header.

In some examples, a pre-processing of the first data table and of the second data table can be performed. In this pre-processing, the row headers (or column headers) of the first data table can be extracted and stored in first look-up table. The first look-up table includes the row headers of the first data table, and the index (row number, or column number) of each of the row headers (or column headers) of the first data table. This first look-up table can be loaded/stored in a computer-readable memory. The row headers (or column headers) of the second data table can be extracted and stored in a second look-up table. The second look-up table includes the row headers (or column headers) of the second data table, and the index (row number or column number) of each of the row headers (column headers) of the second data table. This second look-up table can be loaded/stored in a computer-readable memory. Usage of the first and/or second look-up table(s) enables manipulating the row headers (or column headers), and not manipulating each time the whole first and/or second data table in the various operations that involve the row or column headers (e.g., cleaning of the headers, matching the data tables based on the headers, fusing the data tables). Note that the first and second look-up tables can be used in various operations described in the present specification: cleaning of the row or column headers (this enables cleaning the format of the row or column headers without requiring manipulating the whole data tables), matching of the data tables based on the row or column headers (this enables identifying the matching row or column headers without requiring manipulating the whole data tables), fusion of the data tables, etc.

The method of FIG. 6A comprises comparing (operation 610) the row headers of the first data table with the row headers of the second data table. Depending on the output of this comparison, it can be decided whether the first data table and the second data table match each other (operation 620). In some examples, if the output of the comparison complies with a matching criterion, it can be decided that the first data table and the second data table match each other. In some examples, a match between the data tables is detected according to the matching criterion, when the percentage of row headers of the first table that match the row headers of the second table is above a certain threshold. The threshold can be preset or can be defined in the configuration parameters.

In some examples (see FIG. 6B), assume that a set of N data tables has been obtained, wherein each respective data table includes a plurality of rows, each associated with a respective row header (operation 601). In this case, the method of FIG. 6B can include (operation 611) comparing the row headers of a given data table with the row headers of the other data tables. Each comparison outputs a score (e.g., a percentage). The comparison which outputted the highest score can be used to identify the data table of the set which best matches the given data table (operation 621). Note that it is possible to require that the highest score be also above a certain threshold in order to determine a match. This ensures that there is an actual match between the data tables. Indeed, it can occur that the highest score is in fact very low and does not correspond to an actual match. If no matching data table has been identified, this indicates that the given data table does not match any other data tables of the set. The given data table can be classified as part of the non-matching data tables. Operation 610 and 620 can be repeated for the different data tables of the set.

In some examples, the comparison between the row headers disregards leading and trailing white spaces. Therefore, even if two row headers differ because of leading and/or trailing white spaces, they are considered as matching. In some examples, the comparison between the row headers is case insensitive.

In some examples, the format of the row headers may be pre-processed in order to remove the leading and trailing white spaces in the row headers, and to convert all capital letters into lowercase letters (thereby enabling a comparison which is insensitive to trailing and leading white spaces, and to capital letters). Note that this pre-processing can be used to determine the row headers (or column headers) that match during the matching of the data tables, and also during the generation of aggregated rows (or columns) based on matching row headers (or column headers). However, when selecting the row header (or column header) of an aggregated row (or column) of the aggregated data table, it is possible to use the original row header (or original column header) of the first data table, or of the second data table, before this pre-processing. This is however not limitative.

In some examples, the comparison between the row headers uses a string matching algorithm, such as (but not limited to), a Fuzzy matching algorithm.

Note that the decision of identifying matching data tables based on the row headers can be based on the configuration parameter(s) which indicate that this criterion has to be used. As mentioned above, this can correspond to a user's choice.

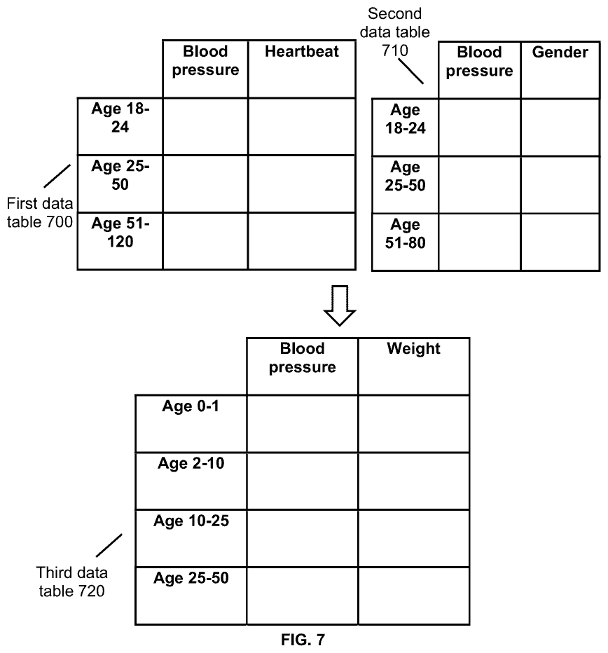

A non-limitative example of the methods of FIGS. 6A and 6B is depicted in FIG. 7. Three data tables 700, 710, and 720 are present in the set of data tables. The matching percentages computed using the method of FIG. 6A or of FIG. 6B are as follows:
Between the first data table 700 and the second data table 710: 66%;
Between the first data table 700 and the third data table 720: 25%;
Between the second data table 700 and the third data table 720: 25%.
   Assume that the matching threshold is set equal to 50%. In light of the foregoing, the first data table 700 and the second data table 710 are determined as matching data tables.

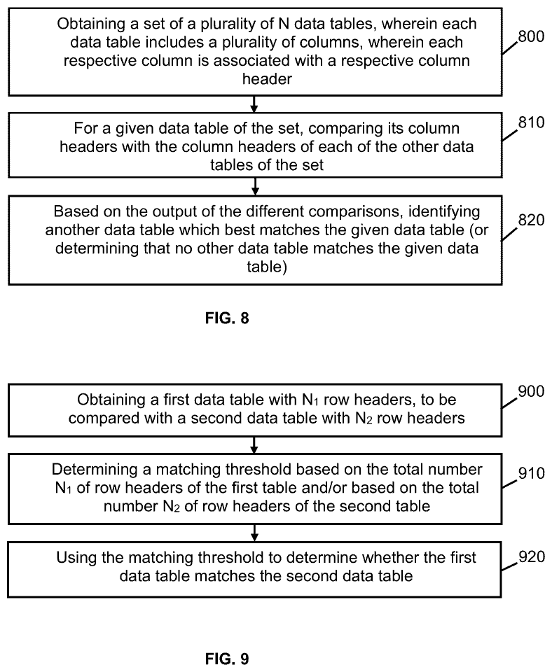

Note that the method of FIG. 6A or of FIG. 6B can be implemented for detecting matching data tables based on the matching of the column headers. This is illustrated in FIG. 8.

Assume that a set of N data tables has been obtained (operation 800), wherein each respective data table includes a plurality of columns, each associated with a respective column header. In this case, the method of FIG. 8 can include (operation 810) comparing the column headers of a given data table with the column headers of the other data tables. Each comparison outputs a score (e.g., a percentage). The comparison which outputted the highest score can be used to identify the data table of the set which best matches the given data table (operation 820). Note that it is possible to require that the highest score be also above a certain threshold in order to determine a match. This ensures that there is an actual match between the data tables. Indeed, it can occur that the highest score is in fact very low and does not correspond to an actual match. If no matching data table has been identified, this indicates that the given data table does not match any other data tables of the set. The given data table can be classified as part of the non-matching data tables. Operation 810 and 820 can be repeated for the different data tables of the set.

In some examples, the match between the data tables based on the comparison of the respective row headers (or column headers) can be assessed based on a variable matching threshold. This is illustrated in FIG. 9. Assume that a first data table and a second data table are obtained (operation 900). The first data table, which is associated with Ni row headers, has to be compared with the second data table, which is associated with N₂ row headers. The method of FIG. 9 includes determining (operation 910) a matching threshold based on the total number N₁ of row headers of the first table and/or based on the total number N₂ of row headers of the second table. The matching threshold indicates the level of matching that is required to declare a match between the data tables (or equivalently indicates how many row headers are allowed to be different between the two data tables in order to detect a match). Since the matching threshold depends on the total number of row headers of at least one of the two data tables that are compared, it is a variable matching threshold, which can vary among the set of data tables. Note that the matching threshold can be expressed as a percentage of row headers that need to match. The level of matching between the row headers of the first data table and the row headers of the second data table is determined based on the matching threshold (operation 920). If this level of matching is equal to or above the matching threshold, a match is declared. If this level of matching is below the matching threshold, a mismatch is declared.

Different rules can be used to define the relationship between the matching threshold and the total number N₁ of row headers of the first table and/or the total number N₂ of row headers of the second table.

In some examples, the higher the value N₁, the smaller the matching threshold.

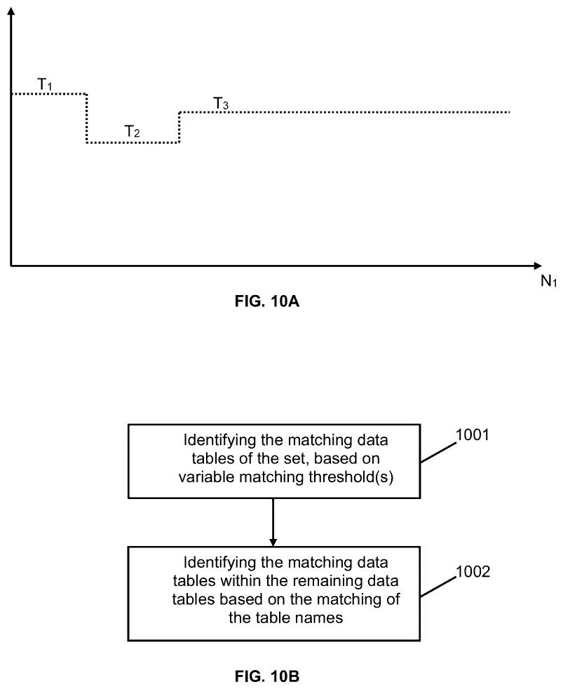

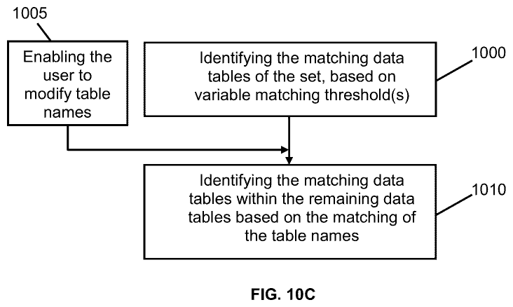

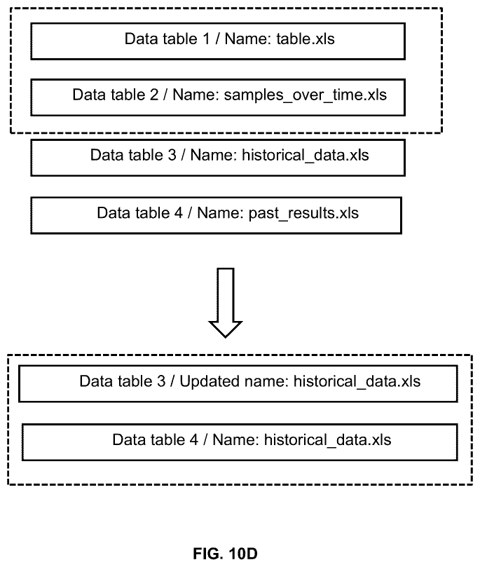

In some examples (see FIG. 10A), when N₁ is between 1 and a first integer I₁, the matching threshold has a value T₁, when N₁ is between the first integer I₁ and a second integer I₂, the matching threshold has a value T₂ and when N₁ is larger than the second integer, the matching threshold has a value T₃, with T₂<T₃<T₁. Other rules can be used depending on the needs and/or the application.

As mentioned above, comparison of the data tables can include comparing the respective column headers (see FIG. 8). In this case, the variable matching threshold can be defined similarly by taking into account the total number of column headers of the first data table and/or the total number of column headers of the second data table. This implementation is not described again, and one can refer to the description above by replacing the row headers with the column headers.

Attention is now drawn to FIG. 10B.

Assume that a set of data tables has been obtained. The method of FIG. 10B includes (operation 1001) identifying the matching data tables of the set, based on variable matching threshold(s), as described with reference to the method of FIG. 9. As mentioned above, this can include comparing the row or column headers, after processing of their format (removing of spaces, etc.). This processing can include using look-up tables. For each pair of data tables that need to be compared, the matching threshold is computed based on the number of row headers (or the number of column headers) of at least one data table of the pair. The level of matching can be assessed by comparing the row headers or the column headers of the respective data tables of the pair, and determining whether the level of matching is compliant with the matching threshold. One or more pairs of matching data tables are identified within the set.

The data tables of the set, which have not been identified as matching data tables, are then processed. These data tables are designated hereinafter as the set of non-matching data tables. As can be understood from the description hereinafter, the term of “non-matching data table(s)” may be temporary, since additional operations (see operation 1002) are performed in order to attempt to identify matching data tables within this set of non-matching data tables.

The method of FIG. 10B further includes (operation 1002) processing the set of non-matching data tables and identifying, within this set, matching data tables based on the matching of the table names (as described with reference to FIG. 4). In some examples, after operation 1001, the user can decide to modify the names of one or more data tables, in order to obtain an updated set of data tables. The updated set of data tables can be uploaded again, and then operations 1001 and 1002 are performed again on this updated set of data tables.

Attention is now drawn to FIG. 10C.

Assume that a set of data tables has been obtained. The method of FIG. 10B includes (operation 1000) identifying the matching data tables of the set, based on variable matching threshold(s), as described with reference to the method of FIG. 9. In particular, for each pair of data tables that need to be compared, the matching threshold is computed based on the number of row headers (or the number of column headers) of at least one data table of the pair. The level of matching can be assessed by comparing the row headers or the column headers of the respective data tables of the pair, and determining whether the level of matching is compliant with the matching threshold. One or more pairs of matching data tables are identified within the set. Regarding the remaining data tables of the set, that have not been identified as matching with another data table, the method of FIG. 10B further includes (operation 1010) identifying the matching data tables within the remaining data tables based on the matching of the table names (as described with reference to FIG. 4). In some examples, after operation 1100, the user is invited or allowed to modify the name of one or more of the data tables (operation 1005). For example, a request can be sent from the computerized system 100 to the user, which invites the user to modify the table names. This enables the user to “force” the matching of certain data tables, by selecting table names which are similar.

A non-limitative example of the method of FIG. 10B is illustrated in FIG. 10C. Assume that four data tables have been obtained. At operation 1000, matching data tables are identified by comparing the row headers and using a variable matching threshold (which depends on the number of rows of data tables that are compared). Data table 1 and data table 2 are identified as matching data tables, whereas data table 3 and data table 4 are identified as non-matching data tables. The user is invited to modify the names of the remaining data tables 3 and 4. He modifies the name of the data table 4 from “past_results.xls” to “historical_data.xls”. At operation 1010, the updated names of the data tables are compared in order to identify the matching data tables. Data table 3 and data table 4 are identified as matching data tables. The various methods described above can be combined. In particular, it is possible to determine a match between data tables based on the match of the table names and of the row headers. It is also possible to determine a match between data tables based on the match of the table names and of the column headers. It is also possible to determine a match between data tables based on the match of the row headers and of the column headers. It is also possible to determine a match between data tables based on the match of the row headers, of the column headers, and of the table names. In all of these methods, it is possible to use a fixed matching threshold or a variable matching threshold.

Reverting to the method of FIG. 2, the pairs of matching data tables are transferred to the fusion module 112, which is operative to perform the fusion (aggregation) of matching data tables.

For each respective pair of matching data tables, the method of FIG. 2 includes fusing (operation 210) the matching data tables of the respective pair into an aggregated data table. Note that for a given pair, the data table corresponding to the first data table can be selected based on parameters defined in the configuration parameters and/or based on a manual input of the user and/or based on the names of the data tables.

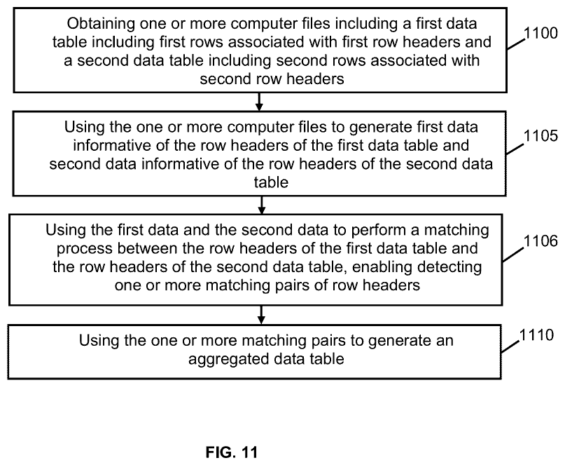

FIG. 11 depicts a method enabling fusing two data tables (e.g., two matching data tables). In this method, the fusion is performed along the rows. Assume that one or more computer files have been obtained, which include a first data table including first rows associated with respective first row headers, and a second data table including second rows associated with respective second row headers. Assume that the first and second data tables have been identified as matching data tables (operation 1100).

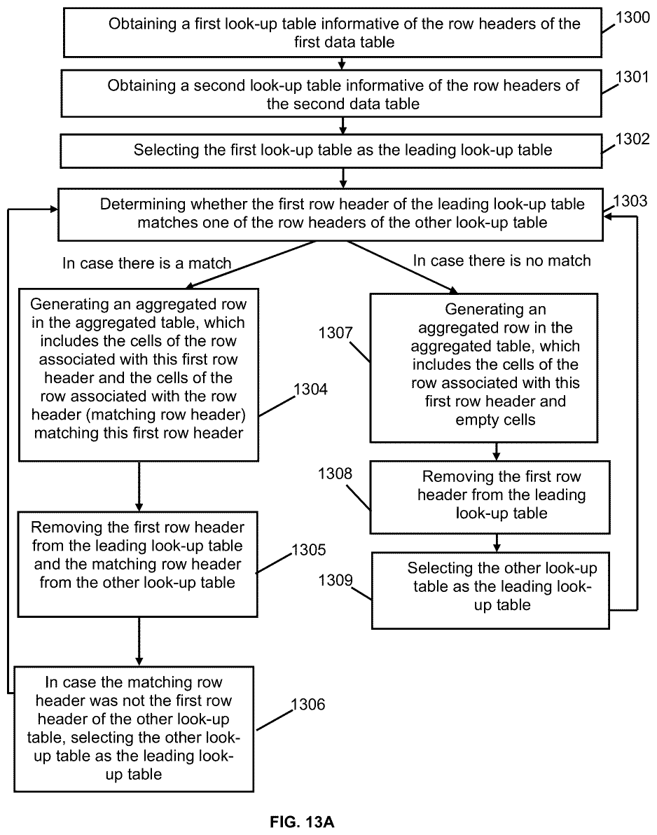

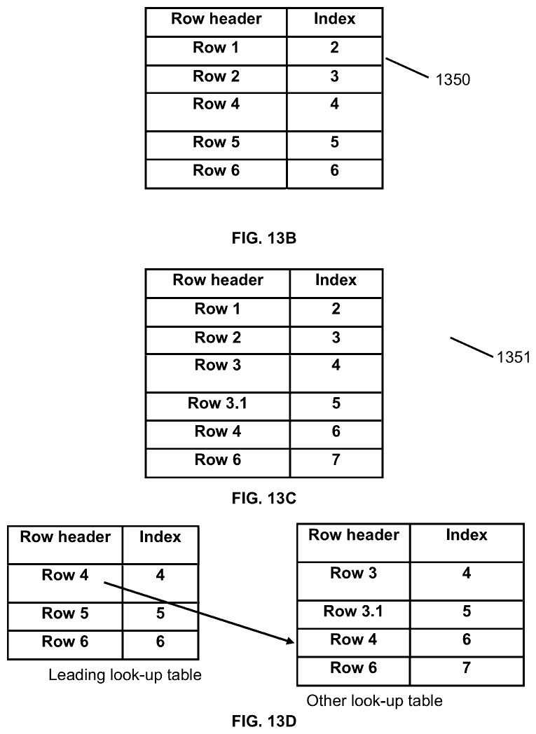

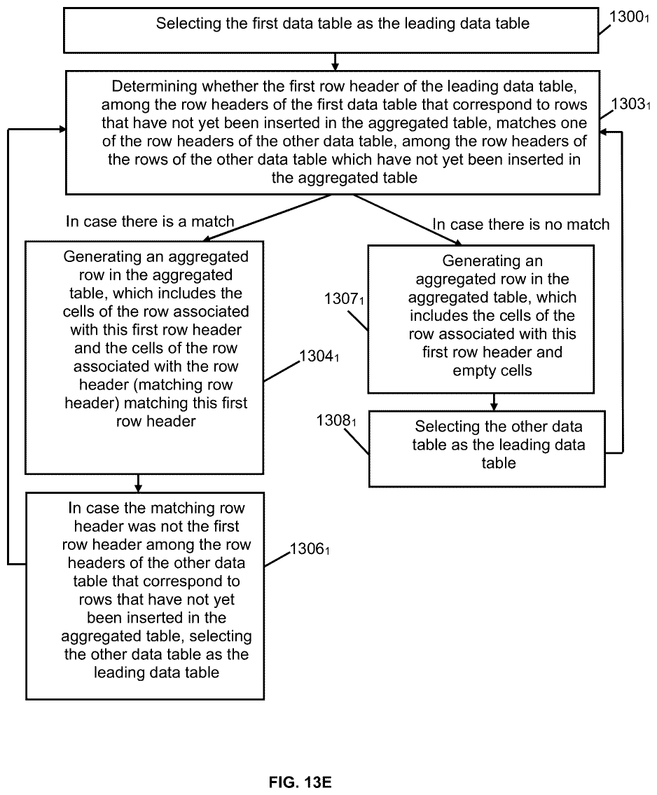

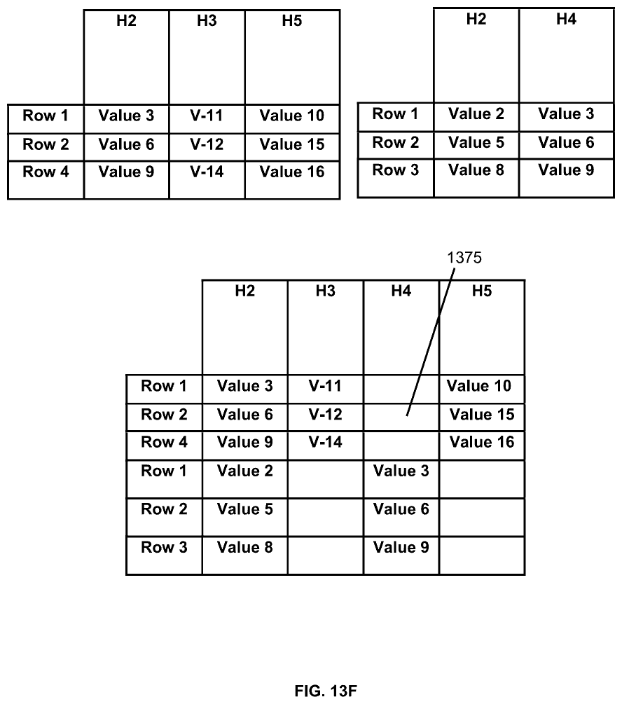

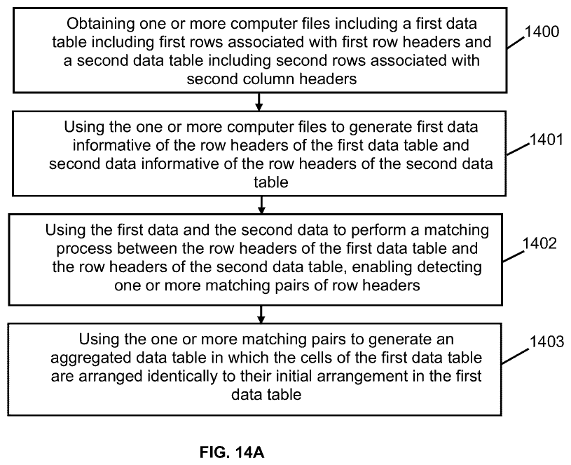

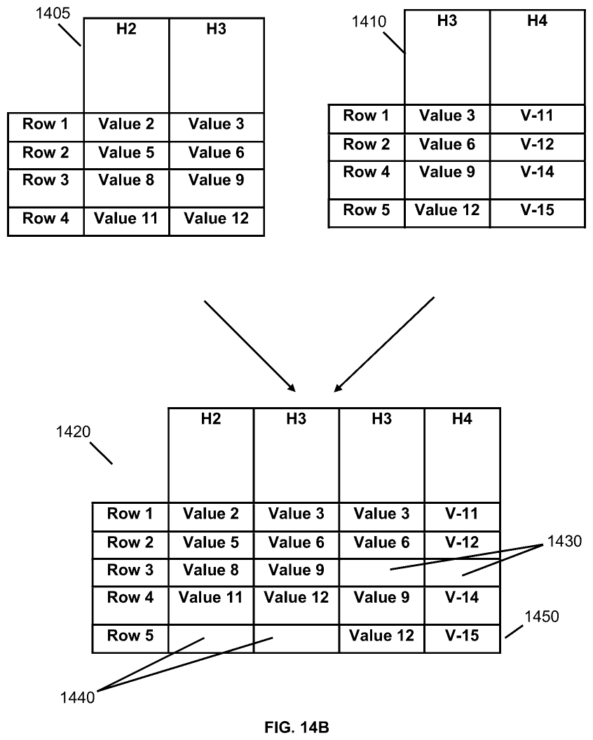

The method of FIG. 11 includes using (operation 1105) the one or more computer files to generate first data informative of the row headers of the first data table, and second data informative of the row headers of the second data table. The first data can include the row headers of the first data table, after pre-processing (e.g., removing of leading and trailing white spaces, conversion of capital letters into lowercase letters, etc.). Similarly, the second data can include the row headers of the second data table, after pre-processing (e.g., removing of leading and trailing white spaces, conversion of capital letters into lowercase letters, etc.). In some examples, and as explained with reference to FIG. 13A, the first data includes a look-up table informative of the row headers of the first data table, and the second data includes a look-up table informative of the row headers of the second data table.

The method of FIG. 11 includes using (operation 1106) the first data and the second data to perform a matching process between the row headers of the first data table and the row headers of the second data table, enabling detection of one or more matching pairs of row headers. Each given matching pair of the one or more matching pairs comprising a given row header is associated with a given first row of the first data table and a given row header is associated with a given second row of the second data table.

The method of FIG. 11 includes using the one or more matching pairs to generate (operation 1110) the aggregated data table (also called fused data table). The aggregated data table is such that, for each given first row associated with a given first row header which matches a given second row header of a given second row of the one or more second rows, the aggregated data table comprises a given aggregated row corresponding to an aggregation of the given first row and the given second row. In other words, each row header which is common between the two data tables leads to the generation of an aggregated row including at least part (or all of) the first row of the first data table and at least part (or all of) the second row of the second data table. It has been mentioned that the aggregated row includes at least part of the first row and/or the second row. since the row header which is common to the first and second rows is not present twice in the aggregated row. In addition, in some examples, it can occur that the row header of the first row and of the second row slightly differ (e.g., due to the presence of space, or due to the presence of a different casing), and that the aggregated row includes the row header of one of the two rows.

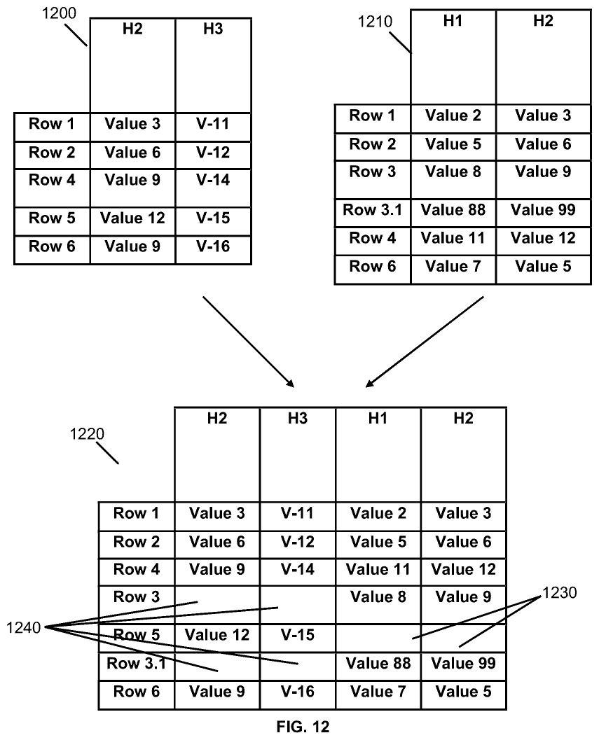

A non-limitative example is provided in FIG. 12. The following row headers are common between the first data table 1200 and the second data table 1210: Row 1, Row 2, Row 4, and Row 6. Therefore, for these row headers, the aggregated data table 1220 includes:
For the row header “Row 1”, the aggregated data includes the cells of the first row of the first data table, the cells of the second row of the second data table, and the row header “Row 1” (note that the row header “Row 1” is not present twice, since it is common to the data tables);
For the row header “Row 2”, the aggregated data includes the cells of the first row of the first data table, the cells of the second row of the second data table, and the row header “Row 2” (note that the row header “Row 2” is not present twice, since it is common to the data tables);
For the row header “Row 4”, the aggregated data includes the cells of the first row of the first data table, the cells of the second row of the second data table, and the row header “Row 4” (note that the row header “Row 4” is not present twice, since it is common to the data tables);
For the row header “Row 6”, the aggregated data includes the cells of the first row of the first data table, the cells of the second row of the second data table, and the row header “Row 6” (note that the row header “Row 6” is not present twice, since it is common to the data tables).

Operation 1110 also includes generating the aggregated data table such that, for each given first row associated with a given first row header which does not match any one of the one or more second row headers, the aggregated data table comprises a given aggregated row comprising the given first row, and one or more empty cells, wherein a number of the one or more empty cells depends on the number of columns of the second data table. In particular, the number of empty cell(s) can be selected as equal to the number of columns (without the column of the row headers) of the second data table.

A non-limitative example is provided in FIG. 12. The following row header of the first data table 1200 is not present in the second data table 1210: Row 5. Therefore, for this row header, the aggregated data table 1220 includes the first row of the first data table, and two empty cells 1230 (since the second data table includes two columns with the column of the row headers).

Operation 1110 also includes generating the aggregated data table such that, for each given second row of the one or more second rows, associated with a given second row header which does not match any one of the one or more first row headers, the aggregated data table comprises a given aggregated row comprising the given second row, and one or more empty cells, wherein a number of the one or more empty cells depends on the number of columns of the first data table. In particular, the number of empty cell(s) can be selected as equal to the number of columns (without the column of the row headers) of the first data table.

A non-limitative example is provided in FIG. 12. The following row headers of the second data table 1210 are not present in the first data table 1200: Row 3 and Row 3.1. Therefore, for each of these row headers, the aggregated data table 1220 includes the second row of the second data table, and two empty cells 1240 (since the first data table includes two columns with the column of the row headers).

Note that it is possible to perform a fusion of the data tables along the columns.

In this case, the aggregated data table is such that, for each given first column associated with a given first column header which matches a given second column header of a given second column of the one or more second columns, the aggregated data table comprises a given aggregated column corresponding to an aggregation of the given first column and the given second column. In other words, each column header, which is common between the two data tables, leads to the generation of an aggregated column including at least part (or all of) the first column of the first data table and at least part (or all of) the second column of the second data table. It has been mentioned that the aggregated column includes at least part of the first column and/or the second column since the column header which is common to the first and second columns is not present twice. In addition, in some examples it can occur that the column header of the first column and of the second column slightly differ (e.g., due to the presence of space, or due to the presence of a different casing), and that the aggregated column includes the column header of one of the two columns.

The aggregated data table is such that, for each given first column associated with a given first column header which does not match any one of the one or more second column headers, the aggregated data table comprises a given aggregated column comprising the given first column, and one or more empty cells, wherein a number of the one or more empty cells depends on the number of rows of the second data table. In particular, the number of empty cell(s) can be selected as equal to the number of rows (without the row of the column headers) of the second data table.

The aggregated data table is such that, for each given second column of the one or more second columns, associated with a given second column header which does not match any one of the one or more first column headers, the aggregated data table comprises a given aggregated column comprising the given second column, and one or more empty cells, wherein a number of the one or more empty cells depends on the number of rows of the first data table. In particular, the number of empty cell(s) can be selected as equal to the number of rows (without the row of the column headers) of the first data table. This is visible in FIG. 13F, in which the aggregated column with column header H4 includes three empty cells 1375 followed by the cells of the column of the second data table with column header H4.

FIG. 13A describes a method enabling fusing two data tables along the rows, in an efficient way.

The method of FIG. 13A includes generating (operation 1300) a first look-up table (see e.g., reference 1350 in FIG. 13B) informative of the row headers of the first data table. The first look-up table includes the row headers of the first data table, and the index (row number) of each of the row headers of the first data table. This first look-up table can be loaded/stored in a computer-readable memory. Usage of the first look-up table enables manipulating the row headers, and not manipulating each time the whole first data table in the process of aggregating the first and second data tables.

The method of FIG. 13A includes generating (operation 1301) a second look-up table (see e.g., reference 1351 in FIG. 13C) of row headers of the second data table. The second look-up table includes the row headers of the second data table, and the index (row number) of each of the row headers of the second data table. This second look-up table can be loaded/stored in a computer-readable memory. This enables manipulating the row headers, and not manipulating each time the whole second data table in the process of aggregating the first and second data tables.

The method of FIG. 13A includes selecting (operation 1302) the first look-up table or the second look-up table as the leading look-up table. Assume that the first look-up table has been selected as the leading look-up table. The leading look-up table dictates which row header will be used for the next aggregated row of the aggregated data table. In particular, each time a next aggregated row needs to be created, the first row header of the leading look-up table is used as the row header of this next aggregated row.

The method of FIG. 13A includes determining (operation 1303) whether the first row header (the first row header of a look-up table is the one with the smallest index value in this look-up table) of the leading look-up table matches one of the row headers of the other look-up table.

In case there is a match, the method of FIG. 13A includes generating (operation 1304) an aggregated row in the aggregated data table, which includes the cells of the row of the first data table associated with this first row header (in this example, “Row 1” of the first data table 1200) and the cells of the row of the second data table associated with the row header (hereinafter matching row header) matching this first row header (in this example, “Row 1” of the second data table 1210). This aggregated row is associated with a row header which is based on the first row header and/or based on the matching row header. For example, the aggregated row is associated with the row header (“Row 1”).

The method of FIG. 13A includes removing (operation 1305) the first row header from the leading look-up table and removing the matching row header of the other look-up table.

The method of FIG. 13A further includes reverting to operation 1303. In the example of FIG. 12, the first row header of the leading look-up table is now “Row 2”, which matches the row header “Row 2” of the other look-up table. This yields the generation of the aggregated row “Row 2” as visible in FIG. 12. The first row header “Row 2” of the leading look-up table is removed from the leading look-up table, and the row header “Row 2” is removed from the other look-up table.

The method of FIG. 13A further includes reverting to operation 1303. In the example of FIG. 12, the first row header of the leading look-up table is now “Row 4”, which matches the row header “Row 4” of the other look-up table (see FIG. 13D). This yields the generation of the aggregated row “Row 4”, as visible in FIG. 12. The first row header “Row 4” of the leading look-up table is removed from the leading look-up table, and the row header “Row 4” is removed from the other look-up table. Since the matching row header (“Row 4”) was not the first row header of the other look-up table (but only the third row header), the method of FIG. 13A further includes selecting the other look-up table as the leading look-up table (operation 1306).

The method of FIG. 13A further includes reverting to operation 1303. In the example of FIG. 12, the first row header of the leading look-up table (now corresponding to the second look-up table) is now “Row 3”, which does not match any row header of the other look-up table (first look-up table). In this case, the method of FIG. 13A further includes generating (operation 1307) an aggregated row in the aggregated data table, which includes the cells of the row associated with this first row header and empty cell(s). In the example of FIG. 12, the aggregated row “Row 3” first includes the empty cell(s) and then the cells of “Row 3” of the second data table. In this example, the number of empty cell(s) is selected as the number of columns of the first data table, without the column of the row headers.

The method of FIG. 13A further includes (operation 1308) removing the first row header from the leading look-up table, and selecting (operation 1309) the other look-up table as the leading look-up table.

The method of FIG. 13A further includes reverting to operation 1303. In the example of FIG. 12, the first row header (with the smallest index value) of the leading look-up table (now corresponding to the first look-up table) is now “Row 5”, which does not match any row header of the other look-up table (second look-up table). In this case, the method of FIG. 13A further includes generating (operation 1307) an aggregated row in the aggregated data table, which includes the cells of the row associated with this first row header and empty cell(s). In the example of FIG. 12, the aggregated row “Row 5” first includes the cells of “Row 5” of the first data table and then empty cell(s). In this example, the number of empty cell(s) is selected as the number of columns of the second data table, without the column of the row headers. The method of FIG. 13A further includes (operation 1308) removing the first row header from the leading look-up table, and selecting (operation 1309) the other look-up table as the leading look-up table.

In the example of FIG. 12, the first row header of the leading look-up table (now corresponding to the second look-up table) is now “Row 3.1”, which does not match any row header of the other look-up table (second look-up table). In this case, the method of FIG. 13A further includes generating (operation 1307) an aggregated row in the aggregated data table, which includes the cells of the row associated with this first row header and empty cell(s). In the example of FIG. 12, the aggregated row “Row 3.1” first includes the cells of “Row 3.1” of the first data table and then empty cell(s). In this example, the number of empty cell(s) is selected as the number of columns of the second data table, without the column of the row headers. The method of FIG. 13A further includes (operation 1308) removing the first row header from the look-up table, and selecting (operation 1309) the other look-up table as the leading look-up table.

The method of FIG. 13A further includes reverting to operation 1303. In the example of FIG. 12, the first row header of the leading look-up table (now corresponding to the first look-up table) is now “Row 6”, which matches the remaining row header of the other look-up table (second look-up table). In this case, the method of FIG. 13A further includes generating (operation 1304) an aggregated row in the aggregated data table, which includes the cells of the row associated with this first row header and the cells of the row associated with the matching row header.

The method of FIG. 13A includes using look-up tables informative of the respective data tables. Note that this is not mandatory, as visible in FIG. 13E.

The method of FIG. 13E includes selecting (operation 1300₁) the first data table as the leading data table. The leading data table dictates which row header will be used for the next aggregated row of the aggregated data table. In particular, each time a next aggregated row needs to be created, the first row header of the leading data table (among the row headers which have not yet been used to generate an aggregated row) is used as the row header of this next aggregated row.

The method of FIG. 13E includes determining (operation 1303₁) whether the first row header of the leading data table, among the row headers of the first data table that correspond to rows that have not yet been inserted in the aggregated data table, matches one of the row headers of the other data table, among the row headers of the rows of the other data table which have not yet been inserted in the aggregated data table. In this operation, the rows that have already been inserted in the aggregated data table are ignored.

In case there is a match, the method of FIG. 13E includes generating (operation 1304₁) an aggregated row in the aggregated data table, which includes the cells of the row of the first data table associated with this first row header (in the example of FIG. 12, “Row 1” of the first data table 1200) and the cells of the row of the second data table associated with the row header (hereinafter matching row header) matching this first row header (in this example, “Row 1” of the second data table 1210). This aggregated row is associated with a row header which is based on the first row header and/or based on the matching row header. For example, the aggregated row is associated with the row header (“Row 1”).

The method of FIG. 13E further includes reverting to operation 1303₁. In the example of FIG. 12, the first row header of the leading data table (among the row headers corresponding to rows which have not yet been inserted in the aggregated data table) is now “Row 2”, which matches the row header “Row 2” of the other data table. This yields the generation of the aggregated row “Row 2” as visible in FIG. 12.

The method of FIG. 13E further includes reverting to operation 1303₁. In the example of FIG. 12, the first row header of the leading data table is now “Row 4”, which matches the row header “Row 4” of the other data table. This yields the generation of the aggregated row “Row 4”, as visible in FIG. 12. Since the matching row header (“Row 4”) was not the first row header of the other data table (among the row headers corresponding to rows of the other data table which have not yet been inserted in the aggregated data table), the method of FIG. 13E further includes selecting the other data table as the leading look-up table (operation 1306).

The method of FIG. 13E further includes reverting to operation 1303₁. In the example of FIG. 12, the first row header of the second data table (among the rows which have not yet been inserted in the aggregated data table) is now “Row 3”, which does not match any row header of the data table (first data table). In this case, the method of FIG. 13A further includes generating (operation 1307₁) an aggregated row in the aggregated data table, which includes the cells of the row associated with this first row header and empty cell(s). In the example of FIG. 12, the aggregated row “Row 3” first includes the empty cell(s) and then the cells of “Row 3” of the second data table. In this example, the number of empty cell(s) is selected as the number of columns of the first data table, without the column of the row headers.

The method of FIG. 13E further includes selecting (operation 1308₁) the other data table as the leading data table.

The method of FIG. 13E further includes reverting to operation 1303₁. In the example of FIG. 12, the first row header (among the rows that have not yet been inserted) of the leading data table (now corresponding to the first data table) is now “Row 5”, which does not match any row header of the other data table (second data table). In this case, the method of FIG. 13E further includes generating (operation 13071) an aggregated row in the aggregated data table, which includes the cells of the row associated with this first row header and empty cell(s). In the example of FIG. 12, the aggregated row “Row 5” first includes the cells of “Row 5” of the first data table and then empty cell(s). In this example, the number of empty cell(s) is selected as the number of columns of the second data table, without the column of the row headers. The method of FIG. 13A further includes selecting (operation 1308₁) the other data table as the leading data table.

In the example of FIG. 12, the first row header of the leading data table (now corresponding to the second data table), among the row headers of the rows that have not yet been inserted in the aggregated data table, is now “Row 3.1”, which does not match any row header of the other data table (second data table). In this case, the method of FIG. 13E further includes generating (operation 1307₁) an aggregated row in the aggregated data table, which includes the cells of the row associated with this first row header and empty cell(s). In the example of FIG. 12, the aggregated row “Row 3.1” first includes the cells of “Row 3.1” of the first data table and then empty cell(s). In this example, the number of empty cell(s) is selected as the number of columns of the second data table, without the column of the row headers. The method of FIG. 13E further includes selecting (operation 1308₁) the other data table as the leading data table.

The method of FIG. 13E further includes reverting to operation 1303₁. In the example of FIG. 12, the first row header of the leading data table (now corresponding to the first data table) is now “Row 6”, which matches the first row header of the other data table (among the row headers of the rows of the second data table which have not yet been inserted in the aggregated data table). In this case, the method of FIG. 13E further includes generating (operation 1304₁) an aggregated row in the aggregated data table, which includes the cells of the row associated with this first row header and the cells of the row associated with the matching row header.

Note that the methods of FIGS. 13A and 13E can be performed to perform a fusion of the two data tables along the columns (in this case, one should replace above “row(s)” by “column(s)” and “column(s)” by “row(s)”). FIG. 13F illustrates a non-limitative example of the method of FIGS. 13A and 13E, used to perform a fusion along the columns.

As visible in the non-limitative example of FIGS. 12 and 13F, these methods (in which the data table/look-up table dictating the next aggregated row is changed in response to an event—see operations 1306 and 1306₁) enables a better combination of the data between the data tables. In particular, spreading of the data is improved. In addition, it enables maintaining a balance between the data from the data tables, by preventing one table's data from dominating the result. It also reduces the bias towards one data table's data.

Attention is now drawn to FIG. 14A, which depicts another method enabling fusing two matching data tables. Assume that one or more computer files have been obtained (operation 1400), which include:
a first data table comprising a plurality of cells (corresponding to the content of the first data table) and headers arranged along first rows and first columns (the headers include row headers and, in some examples, column headers); and
a second data table comprising a plurality of cells (corresponding to the content of the second data table) and headers arranged along second rows and second columns (the headers include row headers and, in some examples, column headers).

The method of FIG. 14A includes using (operation 1401) the one or more computer files to generate first data informative of the row headers of the first data table, and second data informative of the row headers of the second data table. The first data can include the row headers of the first data table, after pre-processing (e.g., removing leading and trailing white spaces, conversion of capital letters into lowercase letters, etc.). Similarly, the second data can include the row headers of the second data table, after pre-processing (e.g., removing leading and trailing white spaces, conversion of capital letters into lowercase letters, etc.). In some examples, the first data includes a look-up table informative of the row headers of the first data table, and the second data includes a look-up table informative of the row headers of the second data table.

The method of FIG. 14A includes using (operation 1402) the first data and the second data to perform a matching process between the row headers of the first data table and the row headers of the second data table, enabling detecting one or more matching pairs of row headers. Each given matching pair of the one or more matching pairs comprising a given row header associated with a given first row of the first data table, and a given row header associated with a given second row of the second data table.

The method of FIG. 14A includes using the one or more matching pairs to generate (operation 1403) an aggregated data table (also called a fused data table).

In the aggregated data table, the cells of the first data table are arranged as they were arranged in the first data table. In particular, the cells of the first data table are arranged identically to their arrangement in the first data table. This limits the impact of the fusion on the data.

In other words, the cells of the first data table appear in the aggregated data table as they appeared in the first data table. Note that the first rows can include row headers (stored e.g., as a column of the first data table). In some examples, the first rows, together with their row headers, appear in the aggregated data table, as they appeared in the first data table. In this case, the first rows and first columns of the first data table are arranged in the aggregated data table as they were arranged in the first data table. It can however occur that the row headers of the first rows appear differently in the aggregated data table than in the first data table, due e.g. to modifications of the font and/or of the spaces between the characters. However, the cells (corresponding to the actual content of the first data table) are arranged in the aggregated data table as they were arranged in the first data table. This is not limitative.

A non-limitative example is illustrated in FIG. 14B, which depicts a first data table 1405 and a second data table 1410. In the aggregated data table 1420, the first data table 1405 appears in accordance with its initial arrangement of rows and columns.

In the method of FIG. 14A, the aggregated data table is such that, for each given first row associated with a given first row header which matches a given second row header of a given second row of the one or more second rows, the aggregated data table comprises a given aggregated row corresponding to an aggregation of the given first row and the given second row. In other words, each row header which is common between the two data tables leads to the generation of an aggregated row, including the first row of the first data table and at least part (or all of) the second row of the second data table.

A non-limitative example is provided in FIG. 14B. The following row headers are common between the first data table 1405 and the second data table 1410: Row 1, Row 2, and Row 4. Therefore, for these row headers, the aggregated data table 1420 includes:
For the row header “Row 1”, the aggregated data includes the cells of the first row of the first data table, the cells of the second row of the second data table, and the row header “Row 1” (note that the row header “Row 1” is not present twice, since it is common to the data tables);
For the row header “Row 2”, the aggregated data includes the cells of the first row of the first data table, the cells of the second row of the second data table, and the row header “Row 2” (note that the row header “Row 2” is not present twice, since it is common to the data tables); and
For the row header “Row 4”, the aggregated data includes the cells of the first row of the first data table, the cells of the second row of the second data table, and the row header “Row 4” (note that the row header “Row 4” is not present twice, since it is common to the data tables).

Operation 1403 also includes generating the aggregated data table such that, for each given first row associated with a given first row header which does not match any one of the one or more second row headers, the aggregated data table comprises a given aggregated row comprising the given first row, and one or more empty cells, wherein a number of the one or more empty cells depends on the number of columns of the second data table. In particular, the number of empty cell(s) can be selected as equal to the number of columns (without the column of the row headers) of the second data table.

A non-limitative example is provided in FIG. 14B. The following row header of the first data table 1405 is not present in the second data table 1410: Row 3. Therefore, for this row header, the aggregated data table 1420 includes the first row of the first data table, and two empty cells 1430 (since the second data table includes two columns with the column of the row headers).

Operation 1403 also includes generating the aggregated data table such that, for each given second row of the one or more second rows, associated with a given second row header which does not match any one of the one or more first row headers, the aggregated data table comprises a given aggregated row comprising the given second row, and one or more empty cells, wherein a number of the one or more empty cells depends on the number of columns of the first data table. In particular, the number of empty cell(s) can be selected as equal to the number of columns (without the column of the row headers) of the first data table.

Since the cells of the first table are inserted in the aggregated data table “as is”, the aggregated rows (see aggregated row 1450 in FIG. 14B), corresponding to row headers of the second data table which do not match with any of the row headers of the first data table, are appended at the end of the aggregated data table (after the first rows of the first data table).

A non-limitative example is provided in FIG. 14B. The following row header of the second data table 1410 is not present in the first data table 1405: Row 5. Therefore, for this row header, the aggregated data table 1420 includes, from left to right, the aggregated row 1450 with the row header “Row 5”, two empty cells 1440 (since the first data table includes two columns without the column of the headers) and the cells of the second row of the second data table (which do not correspond to the row header “Row 5”).

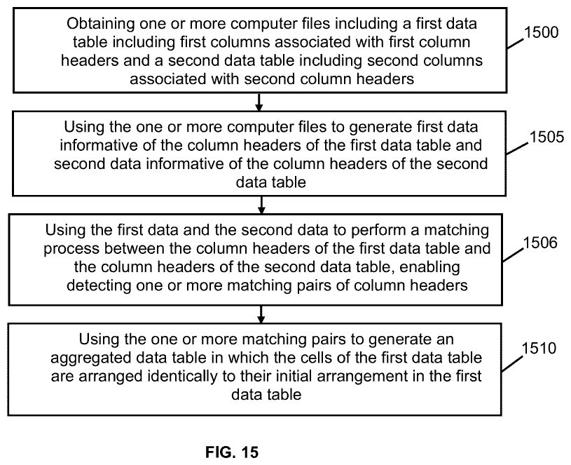

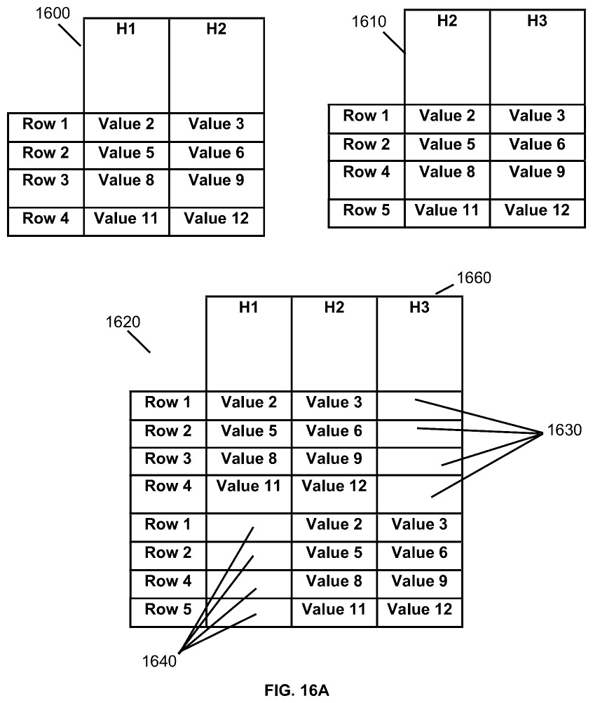

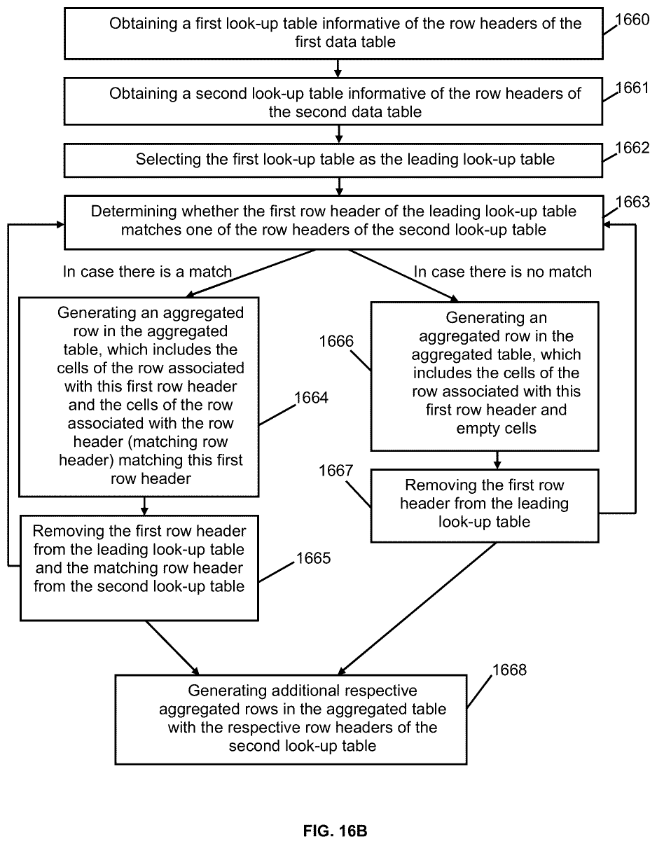

As visible in FIGS. 15 and 16, the method of FIG. 14A can be performed similarly by fusing the data tables along the columns.

Assume that one or more computer files have been obtained (operation 1500), which include:
a first data table comprising a plurality of cells (corresponding to the content of the first data table) and headers arranged along first rows and first columns (the headers include column headers and, in some examples, row headers); and
a second data table comprising a plurality of cells (corresponding to the content of the second data table) and headers arranged along second rows and second columns (the headers include column headers and, in some examples, row headers).

In this case, the method includes using (operation 1505) the one or more computer files to generate first data informative of the column headers of the first data table, and second data informative of the column headers of the second data table. The first data can include the column headers of the first data table, after pre-processing (e.g., removing of leading and trailing white spaces, conversion of capital letters into lowercase letters, etc.). Similarly, the second data can include the column headers of the second data table, after pre-processing (e.g., removing leading and trailing white spaces, conversion of capital letters into lowercase letters, etc.). In some examples, the first data includes a look-up table informative of the column headers of the first data table, and the second data includes a look-up table informative of the column headers of the second data table.

The method includes using (operation 1506) the first data and the second data to perform a matching process between the column headers of the first data table and the column headers of the second data table, enabling detecting one or more matching pairs of column headers. Each given matching pair of the one or more matching pairs comprising a given column header associated with a given first column of the first data table, and a given column header associated with a given second column of the second data table.

The method includes using (operation 1510) the one or more matching pairs to generate an aggregated data table (also called a fused data table).

In the aggregated data table, the cells of the first data table are arranged as they were arranged in the first data table. In particular, the cells of the first data table are arranged identically to their arrangement in the first data table. This limits the impact of the fusion on the data.

In the aggregated data table, the first rows and the first columns of the first data table are arranged identically to their initial arrangement in the first data table. In particular, the order according to which the first rows are arranged in the first table, and the order according to which the first columns are arranged in the first table, is kept in the aggregated data table.

A non-limitative example is illustrated in FIG. 16A, which depicts a first data table 1600 and a second data table 1610. In the aggregated data table 1620, the first data table 1600 appears in accordance with its initial arrangement of rows and columns.

Since the fusion is performed along the columns (see operation 1510), the aggregated data table is such that, for each given first column associated with a given first column header which matches a given second column header of a given second column of the one or more second columns, the aggregated data table comprises a given aggregated column corresponding to an aggregation of the given first column and the given second column. In other words, each column header which is common between the two data tables leads to the generation of an aggregated column, including the first column of the first data table and at least part (or all of) the second column of the second data table.

A non-limitative example is provided in FIG. 16A. The following column header is common between the first data table 1600 and the second data table 1610: “H2”. Therefore, for this column header, the aggregated data table 1620 includes the cells of the first column of the first data table, the cells of the second column of the second data table, and the column header “H2” (note that the column header “H2” is not present twice, since it is common to the two data tables).

Operation 1610 also includes generating the aggregated data table, such that, for each given first column associated with a given column row header which does not match any one of the one or more second column headers, the aggregated data table comprises a given aggregated column comprising the given first column, and one or more empty cells, wherein a number of the one or more empty cells depends on the number of rows of the second data table. In particular, the number of empty cell(s) can be selected as equal to the number of rows (without the row of the column headers) of the second data table.

A non-limitative example is provided in FIG. 16A. The following column header of the first data table 1600 is not present in the second data table 1610: H1. Therefore, for this column header, the aggregated data table 1620 includes the first column of the first data table, and four empty cells 1630 (since the second data table includes four rows without the row of the column headers).

Operation 1610 also includes generating the aggregated data table such that, for each given second column of the one or more second columns, associated with a given second column header which does not match any one of the one or more first column headers, the aggregated data table comprises a given aggregated column comprising the given second column, and one or more empty cells, wherein the number of the one or more empty cells depends on the number of rows of the first data table. In particular, the number of empty cell(s) can be selected as equal to the number of rows (without the row of the row headers) of the first data table.

Since the first table is inserted into the aggregated data table “as is”, the aggregated columns (see aggregated column 1650 in FIG. 16A) corresponding to column headers of the second data table which do not match with any of the column headers of the first data table, are appended at the end of the aggregated data table (after the first columns of the first data table).

A non-limitative example is provided in FIG. 16A. The following column header of the second data table 1610 is not present in the first data table 1600: H3. Therefore, for this column header, the aggregated data table 1620 includes, from top to bottom, the aggregated column 1660 with the row header “H3”, four empty cells 1630 (since the first data table includes four rows without the row of the headers), and the cells of column H3 of the second data table.

Attention is now drawn to FIG. 16B.

In some examples, generation of the aggregated data table in which the cells of the first data table are arranged identically to their initial arrangement in the first data table can rely on the usage of look-up tables.

A first look-up table informative of the row headers of the first data table is generated (operation 1660). The first look-up table includes the row headers of the first data table, and the index (row number) of each of the row headers of the first data table. This first look-up table can be loaded/stored in a computer-readable memory.

A second look-up table informative of the row headers of the second data table is generated (operation 1661). The second first look-up table includes the row headers of the second data table, and the index (row number) of each of the row headers of the second data table. This second look-up table can be loaded/stored in a computer-readable memory.

The method includes selecting (operation 1662) the first look-up table as the leading look-up table. The leading look-up table dictates which row header will be used for the next aggregated row of the aggregated data table.

The method of FIG. 16B includes determining (operation 1663) whether the first row header (the first row header of the first look-up table is the one with the smallest index value in this look-up table) of the leading look-up table matches one of the row headers of the other look-up table.

In case there is a match, the method of FIG. 16B includes generating (operation 1664) an aggregated row in the aggregated data table, which includes the cells of the row of the first data table associated with this first row header and the cells of the row of the second data table associated with the row header matching this first row header. This aggregated row is associated with a row header which is based on the first row header of the first look-up table. The first row header is removed from the first look-up table and the matching row header of the second look-up table is removed from the second look-up table (operation 1665).

In case there is no match, the method of FIG. 16B includes generating (operation 1666) an aggregated row in the aggregated data table, which includes the cells of the row of the first data table associated with this first row header and a number of empty cells equal to the number of columns (except the column of the row headers) of the second data table. The first row header of the first look-up table is then removed (operation 1667).

This process is repeated with the new first row header of the first look-up table, until the first look-up table is empty.

Then, the method of FIG. 16B includes generating (operation 1668) respective aggregated rows in the aggregated data table with the respective row headers of the second look-up table. Each respective aggregated row includes empty cells (the number of empty cells is equal to the number of columns of the first data table, except the column of the row headers) and the cells of the second data table.

Note that the method of FIG. 16B can be performed to perform a fusion of the two data tables along the columns (in this case, one should replace above “row(s)” by “column(s)” and “column(s)” by “row(s)”).

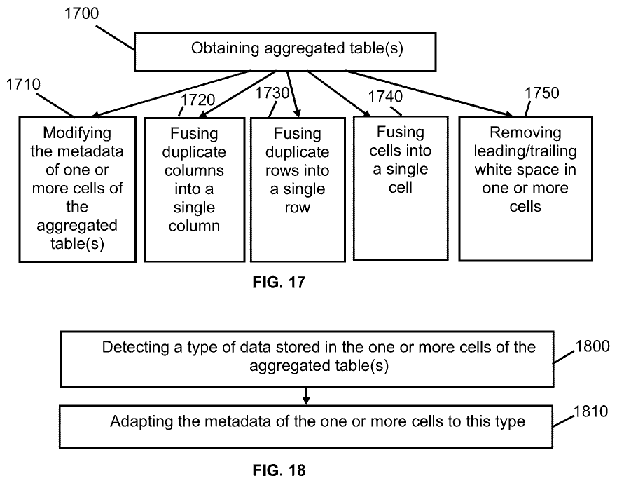

Attention is now drawn to FIG. 17. The aggregated data table(s) generated by the fusion module 112 is/are transferred to the table processing module 113 (operation 1700).

As visible in FIG. 17, the table processing module 113 can perform various processing operations of the aggregated data table(s). Note that the nature and/or the parameters of the processing operations can be defined (e.g., by the user) in the configuration parameters 151.

In some examples (see FIG. 17), processing of the aggregated data table(s) can include modifying (operation 1710) the metadata of one or more cells of the aggregated data table(s). The metadata of a cell corresponds to a label which defines the type of data stored in the cell, and the way it is displayed.

This can include (see FIG. 18) detecting (operation 1800) a type of data stored in the one or more cells of the aggregated data table(s), and adapting (operation 1810) the metadata of the one or more cells to this type. For example:
If the table's cell content is identified as corresponding to a number, the cell metadata can be converted to a number (e.g., conversion of the metadata from general text to a number);
If the table's cell content is identified as corresponding to a currency, the cell metadata can be converted to a currency (e.g., conversion of the metadata from general text to a currency);
If the table's cell content is identified as corresponding to a time, the cell metadata can be converted to time (e.g., conversion of the metadata from general text to a time);
If the table's cell content is identified as corresponding to a date, the cell metadata can be converted to date (e.g., conversion of the metadata from general text to a date).

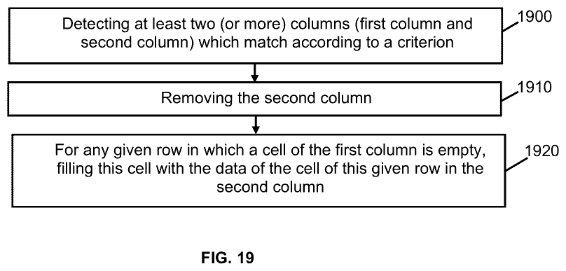

In some examples (see FIG. 17), processing of the aggregated data table(s) can include (operation 1720) fusing redundant columns (duplicate columns) into a single column. This can include (see FIG. 19) detecting (operation 1900) at least two (or more) columns (designated hereinafter as first column and second column) which match according to a criterion. According to some examples, the criterion dictates that: (1) the column header of the first column matches the column header of the second column (e.g., identical characters-a difference in the presence of space(s) or in the upper/lower case is not considered as a mismatch), and (2) for any given row (which does not correspond to the row of the column header), a cell of the first column located in this given row matches a cell of the second column located in this given row, or, one of the two cells is empty. The first and second columns are designated as matching columns.

The method further includes removing (operation 1910) the second column and keeping only the first column. For any given row in which a cell of the first column is empty, the method includes (operation 1920) filling this cell with the data of the cell of this given row in the second column. For a cell of the first column which contains data, this data is kept.

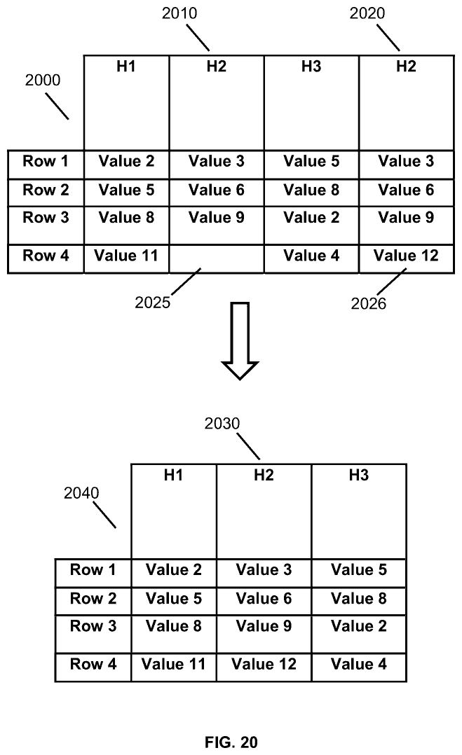

FIG. 20 illustrates an example of the method of FIG. 19, in which column 2010 and column 2020 of the aggregated data table 2000 are identified as matching, and are fused into a single fused column 2030 in the aggregated data table 2040. In row 4 of the aggregated data table 2000, cell 2025, which belongs to column 2010, is empty, and cell 2026, which belongs to column 2020, includes the value “Value 12”. In accordance with the method of FIG. 19, cell 2025 of the fused column 2030 is filled with the value (“Value 12”) of cell 2026.

In some examples, it is possible to allow duplicate rows and/or duplicate columns within the aggregated data table.

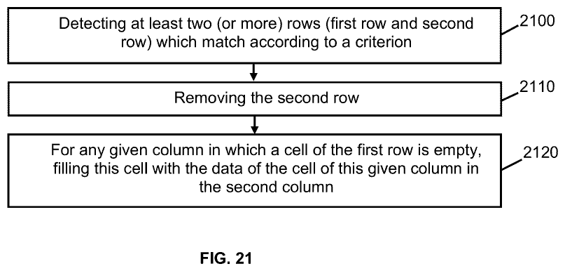

In some examples (see FIG. 17), processing of the aggregated data table(s) can include removing (operation 1730) and fusing redundant rows (duplicate rows) into a single row. This can include (see FIG. 21) detecting (operation 2100) at least two (or more) rows (designated hereinafter as first row and second row) which match according to a criterion. The criterion dictates that: (1) the row header of the first row matches the row header of the second row (e.g., identical characters-a difference in the presence of space(s) or in the upper/lower case is not considered as a mismatch), and (2) for any given column (which does not correspond to the column of the row header), a cell of the first row located in this given column matches a cell of the second row located in this given column, or, one of the two cells is empty. The first and second rows are designated as matching rows.

The method further includes removing (operation 2110) the second row and keeping only the first row. For any given column in which a cell of the first row is empty, the method includes (operation 2120) filling this cell with the data of the cell of this given column in the second row. For a cell of the first row which contains data, this data is kept.

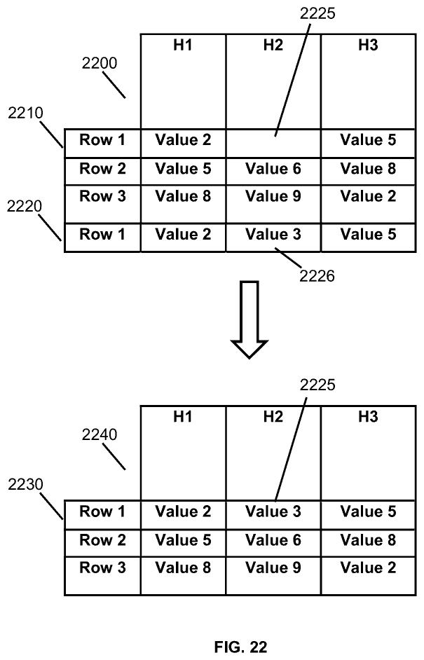

FIG. 22 illustrates an example of the method of FIG. 21, in which row 2210 and the column 2220 of the aggregated data table 2200 are identified as matching, and are fused into a single fused column 2030 in the aggregated data table 2240. In column H2 of the aggregated data table 2200, cell 2225, which belongs to row 2210, is empty, and cell 2226, which belongs to row 2220, includes the value “Value 3”. In accordance with the method of FIG. 22, cell 2225 of the fused column 2230 is filled with the value (“Value 3”) of cell 2226.

In some examples (see FIG. 17), processing of the aggregated data table(s) can include fusing (operation 1740) two cells into a single cell.

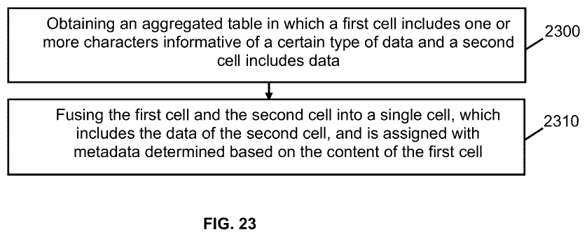

Assume that an aggregated data table is obtained (see operation 2300 in FIG. 23) in which a first cell includes one or more characters informative of a certain type of data (for example, “$” is indicative of a currency, or a character is indicative of time). In some examples, the first cell does not include any numerical value. The aggregated data table includes a second cell (e.g., adjacent to the first cell, in the same row or same column) which includes data. In some examples, the data of the second cell can correspond to numbers only. The method can include (operation 2310) fusing the first cell and the second cell into a single cell, which includes the data of the second cell, and is assigned with metadata (the label of the cell is indicative of the type of cell) determined based on the content of the first cell.

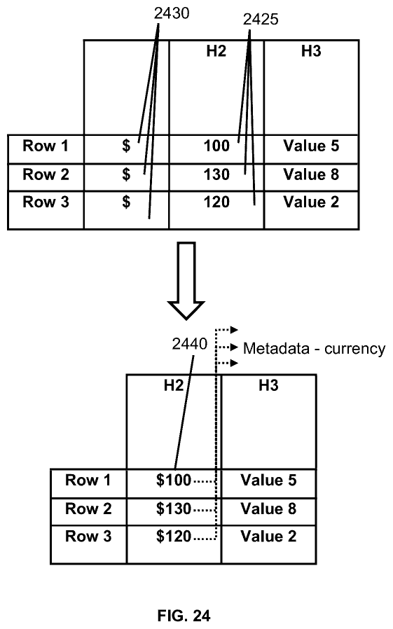

A non-limitative example is illustrated in FIG. 24, in which cells 2430 include only the symbol “$” and cells 2425 (in the adjacent column) include only numerical values. For each row, cell 2430 and cell 2425 are fused into a single cell 2440, with metadata corresponding to a currency.

In some examples (see FIG. 17), processing of the aggregated data table(s) can include removing (operation 1750) leading and/or trailing white space in one or more cells of the aggregated data table(s).

It can occur that a cell includes an unnecessary leading white space before the characters that are stored in the cell. This leading white space can be detected and removed. Detection can be performed by scanning the data of each cell and determining the presence of a white space at the beginning of the cell, followed by the presence of characters. This improves presentation of the data in the aggregated data table.

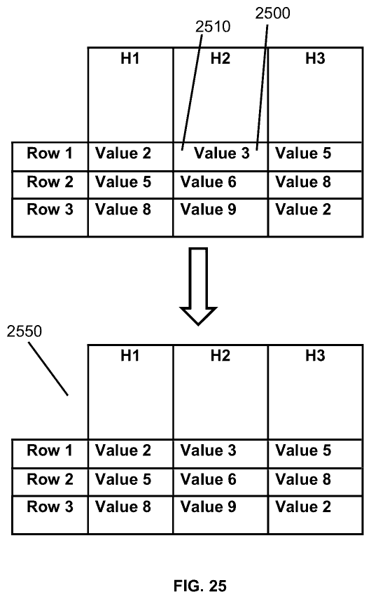

A non-limitative example is provided in FIG. 25, in which cell 2500 includes a leading white space 2510, which has been removed in the aggregated data table 2550.

It can occur that a cell includes an unnecessary trailing white space after the end of the characters that are stored in the cell. This trailing white space can be detected and removed. Detection can be performed by scanning the data of each cell and determining the presence of characters, followed by the presence of a white space, which is not followed by any further characters.

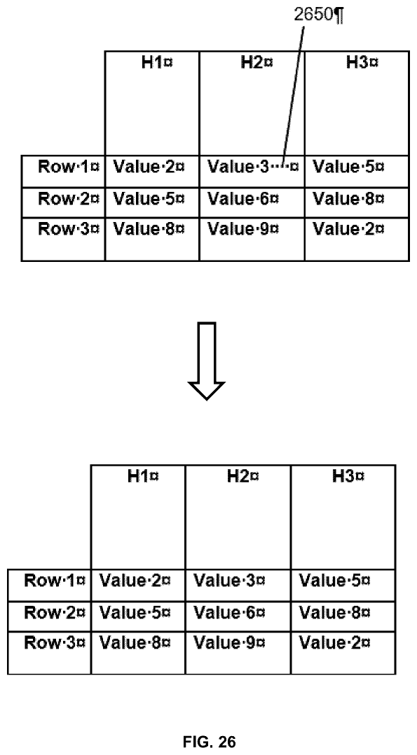

A non-limitative example is provided in FIG. 26, in which the trailing white space 2650 has been removed.

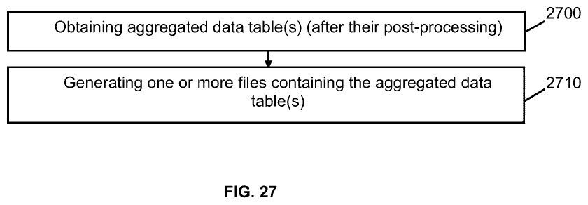

Attention is now drawn to FIG. 27.

Once the aggregated data tables have been processed by the table processing module 113, they are passed on to the orchestration process 114 (operation 2700).

The orchestration process 114 can generate (operation 2710) a single file comprising multiple aggregated data tables, or multiple files (each containing one or more aggregated data tables). The files can then be transmitted back to the user, and/or to the system(s) which uploaded the data tables. The content of the files can be output on an output device, such as a screen.

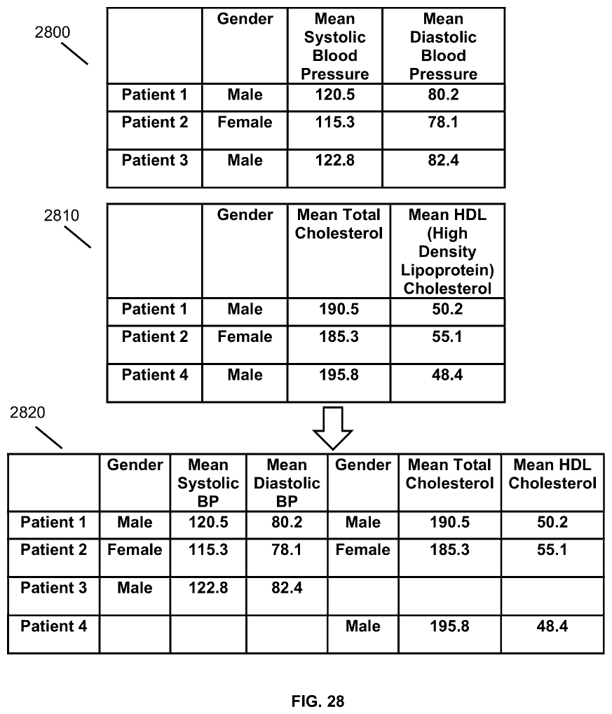

Attention is now drawn to FIG. 28 which illustrates a non-limitative example of at least some of the methods described above.

A first data table 2800 is uploaded by the user, which includes medical data for three patients. A second data table 2810 is uploaded by the user, which also includes medical data for three patients.

The first data table 2800 and the second data table 2810 are fused into an aggregated data table 2820, using the method of FIG. 13. The first data table 2800 appears in the aggregated data table 2820 as it appeared initially before the fusion. For Patient 1 and Patient 2, which are row headers common to the first data table and the second data table, the columns of the second data table are appended to the right side of the last column of the first data table. For Patient 3, whose data is present in the first data table but not in the second data table, three white cells are appended to the right side of the last column of the first data table. For Patient 4, whose data is present in the second data table but not in the first data table, three white cells are inserted, followed by the cells of the second data table.

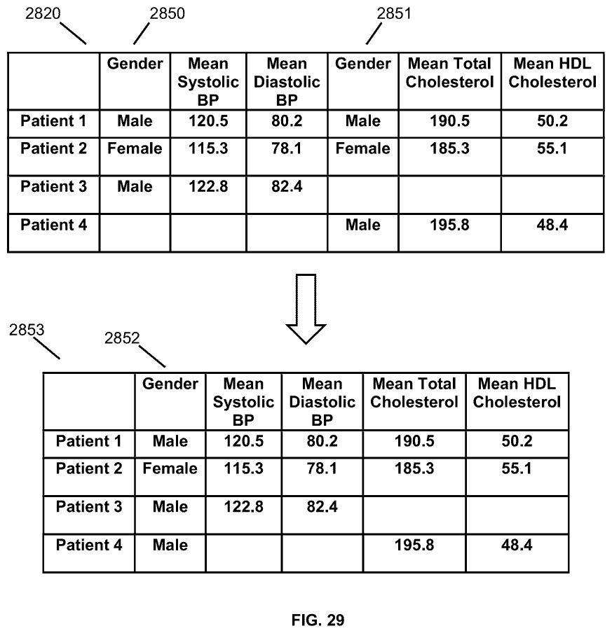

The aggregated data table 2820 is processed (see FIG. 29) according to the method of FIG. 19, in order to fuse matching columns into a single column. In this case, columns 2850 and 2851 are fused into a single column 2852. The aggregated data table 2853 is then obtained.

The various systems and methods can be used in various technical fields such as industry, telecommunications, healthcare, manufacturing, research, finance, and economics. This list is not limitative.

The various systems and methods can be used in various applications such as, but not limited to: identifying relationships between events or changes in time series data (e.g., analyzing the impact of a marketing campaign on sales or the relationship between equipment failures and production downtime), climate data analysis (e.g., join temperature, precipitation, and other climate data to analyze climate patterns and trends), medical data analysis (e.g., combine patient data with treatment data to evaluate the effectiveness of medical interventions), operational analytics, (e.g., performance tracking, such as merging operational data with performance metrics to identify areas for improvement), customer behavior analysis (e.g., combining customer data with website usage data to understand customer preferences and behaviors), predictive analytics (e.g., joining time series data with other relevant data to create predictive models for forecasting future trends, identifying relationships between different time series variables, such as analyzing the correlation between stock prices and economic indicators), comparing trends across different time series, identifying unusual patterns or outliers in time series data by comparing it to historical trends or other related data, efficient data management, etc.

In the detailed description, numerous specific details have been set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the aforementioned discussions, it is appreciated that throughout the specification discussions utilizing terms such as “determining”, “using”, “comparing”, “detecting”, “obtaining”, or the like, refer to the action(s) and/or process(es) of one or more computers (or equivalently one or more processing circuitries) that manipulate and/or transform data into other data, said data represented as physical, such as electronic, quantities and/or said data representing the physical objects.

The terms “computer” or “computer-based system” should be expansively construed to include any kind of hardware-based electronic device with a data processing circuitry (e.g., digital signal processor (DSP), a GPU, a TPU, a field programmable gate array (FPGA), an application specific integrated circuit (ASIC), microcontroller, microprocessor etc.), including, by way of non-limiting example, the computerized system 100 of FIG. 1A and respective parts thereof disclosed in the present application. The data processing circuitry (designated also as processing circuitry) can comprise, for example, one or more processors operatively connected to computer memory, loaded with executable instructions for executing operations, as further described below. The data processing circuitry encompasses a single processor or multiple processors, which may be located in the same geographical zone, or may, at least partially, be located in different zones, and may be able to communicate together. The one or more processors can represent one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application-specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory”, “non-transitory computer-readable medium” and “computer memory” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read-only memory (“ROM”), random access memory (“RAM”), magnetic disk storage media, optical storage media, flash memory devices, etc.

It is to be noted that while the present disclosure refers to the processing circuitry 105 being configured to perform various functionalities and/or operations, the functionalities/operations can be performed by the one or more processors of the processing circuitry 105 in various ways. By way of example, the operations described hereinafter can be performed by a specific processor, or by a combination of processors. The operations described hereinafter can thus be performed by respective processors (or processor combinations) in the processing circuitry 105, while, optionally, at least some of these operations may be performed by the same processor. The present disclosure should not be limited to be construed as one single processor always performing all the operations.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately, or in any suitable sub-combination. In the detailed description, numerous specific details are set forth in order to provide a thorough understanding of the methods and apparatus.

In embodiments of the presently disclosed subject matter, fewer, more, and/or different stages than those shown in the methods of FIGS. 2, 4A, 4B, 6A, 6B, 8, 9, 10B, 11, 13A, 14A, 15, 17, 18, 19, 21, 23, and 27 may be executed. In embodiments of the presently disclosed subject matter, one or more stages illustrated in the methods of FIGS. 2, 4A, 4B, 6A, 6B, 8, 9, 10B, 11, 13A, 14A, 15, 17, 18, 19, 21, 23, and 27 may be executed in a different order, and/or one or more groups of stages may be executed simultaneously.

It is to be understood that the invention is not limited in its application to the details set forth in the description contained herein or illustrated in the drawings.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

What is claimed is

1. A non-transitory computer readable medium comprising instructions that, when executed by one or more computers, cause the one or more computers to:
obtain one or more computer files storing a plurality of data tables comprising a first data table and a second data table, wherein the first data table comprises a plurality of first rows associated with row headers, and the second data table comprises a plurality of second rows associated with row headers,
use the one or more computer files, or data generated from the one or more computer files, to perform a matching process between:
the row headers of the first data table, or data informative of the row headers of the first data table, and
the row headers of the second data table, or data informative of the row headers of the second data table,
said matching process enabling detection of one or more matching pairs of row headers, each given matching pair of the one or more matching pairs comprising a given row header associated with a given first row of the first data table and a given row header associated with a given second row of the second data table, and
use the one or more matching pairs to generate an aggregated data table in which, for each given matching pair, the aggregated data table comprises a given aggregated row comprising:
one or more given cells of the given first row, and
one or more given cells of the given second row.

2. The non-transitory computer readable medium of claim 1, comprising instructions that, when executed by the one or more computers, cause the one or more computers to perform (i), (ii) or both (i) and (ii):
(i) perform an aggregation of the first data table and of the second data table to generate the aggregated data table, said aggregation comprising:
selecting the first data table as a leading data table which dictates which row header among the row headers of the first data table is used for generating a next aggregated row of the aggregated data table, and,
responsive to an event, selecting the second data table as the leading data table which dictates which row header among the row headers of the second data table is used for generating a next aggregated row of the aggregated data table;
(ii) perform an aggregation of the first data table and of the second data table to generate the aggregated data table, said aggregation comprising:
selecting the first data table as a leading data table which dictates which row header among the row headers of the first data table is used for generating a next aggregated row of the aggregated data table, and,
responsive to an event, selecting the second data table as the leading data table which dictates which row header among the row headers of the second data table is used for generating a next aggregated row of the aggregated data table,
wherein said event corresponds to detecting that a first row header of the first data table, among the row headers of the first data table that correspond to rows of the first data table that have not yet been inserted in the aggregated data table, does not match a first row header of the second data table, among the row headers of the second data table that correspond to rows of the second data table that have not yet been inserted in the aggregated data table.

3. The non-transitory computer readable medium of claim 1, comprising instructions that, when executed by the one or more computers, cause the one or more computers to perform (i), (ii) or both (i) and (ii):
(i) use the one or more computer files to generate a first look-up table informative of the row headers of the first data table, and use the first look-up table to process a format of one or more row headers of the first look-up table;
(ii) use the one or more computer files to generate a second look-up table informative of the row headers of the second data table, and use the second look-up table to process a format of one or more row headers of the second look-up table.

4. The non-transitory computer readable medium of claim 1, comprising instructions that, when executed by the one or more computers, cause the one or more computers to perform at least one of (i) to (iv):
(i) perform an aggregation of the first data table and of the second data table to generate the aggregated data table, wherein, in said aggregation, generating of a next aggregated row depends on a selection of a first look-up table or of a second look-up table as a leading look-up table which dictates which row header among the row headers of the first data table or of the second data table is used for generating the next aggregated row, wherein the data generated from the one or more computer files comprises the first look-up table informative of the row headers of the first data table and the second look-up table informative of the row headers of the second data table;
(ii) perform an aggregation of the first data table and of the second data table to generate the aggregated data table, wherein, in said aggregation, generating of a next aggregated row depends on a selection of a first look-up table or of a second look-up table as a leading look-up table which dictates which row header among the row headers of the first data table or of the second data table is used for generating the next aggregated row, wherein the data generated from the one or more computer files comprises the first look-up table informative of the row headers of the first data table and the second look-up table informative of the row headers of the second data table, and use the first row header of the leading look-up table to determine the row header of the next aggregated row of the aggregated data table;
(iii) perform an aggregation of the first data table and of the second data table to generate the aggregated data table, wherein, in said aggregation, generating of a next aggregated row depends on a selection of a first look-up table or of a second look-up table as a leading look-up table which dictates which row header among the row headers of the first data table or of the second data table is used for generating the next aggregated row, wherein the data generated from the one or more computer files comprises the first look-up table informative of the row headers of the first data table and the second look-up table informative of the row headers of the second data table, wherein, when the first look-up table has been selected as the leading look-up table, compare a first row header of the first look-up table with row headers of the second look-up table, and responsive to detecting that the first row header of the first look-up table matches a certain row header of the second look-up table, generate a command for generating an aggregated row including one or more cells of a first row associated with the first row header, and one or more cells of a second row associated with the certain row header;
(iv) perform an aggregation of the first data table and of the second data table to generate the aggregated data table, wherein, in said aggregation, generating of a next aggregated row depends on a selection of a first look-up table or of a second look-up table as a leading look-up table which dictates which row header among the row headers of the first data table or of the second data table is used for generating the next aggregated row, wherein the data generated from the one or more computer files comprises the first look-up table informative of the row headers of the first data table and the second look-up table informative of the row headers of the second data table, wherein, when the first look-up table has been selected as the leading look-up table, compare a first row header of the first look-up table with a first row header of the second look-up table, responsive to detecting that the first row header of the first look-up table does not match the first row header of the second look-up table, generate a command for selecting the second look-up table as the leading look-up table.

5. The non-transitory computer readable medium of claim 1, comprising instructions that, when executed by the one or more computers, cause the one or more computers to:
detect one or more non-matching row headers of the first data table that do not match any row headers of the second data table, and
use the one or more non-matching row headers to generate one or more aggregated rows, wherein each given aggregated row of said one or more aggregated rows comprises one or more cells of a given row associated with a given non-matching row header of the one or more non-matching row headers of the first data table, followed by, in a left-to-right direction, one or more empty cells, wherein a number of the one or more empty cells depends on a number of columns of the second data table.

6. The non-transitory computer readable medium of claim 1, comprising instructions that, when executed by the one or more computers, cause the one or more computers to:
detect one or more non-matching row headers of the second data table that do not match any row headers of the first data table, and
use the one or more non-matching row headers to generate one or more aggregated rows, wherein each given aggregated row of said one or more aggregated rows comprises one or more empty cells, followed by, in a left-to-right direction, one or more cells of a given row associated with a given non-matching row header of the one or more non-matching row headers of the second data table, and wherein a number of the one or more empty cells depends on a number of columns of the first data table.

7. The non-transitory computer readable medium of claim 1, comprising instructions that, when executed by the one or more computers, cause the one or more computers to perform at least one of (i) to (iii):
(i) extract, from the plurality of data tables, one or more pairs of matching data tables, wherein a given pair comprises the first data table and the second data table;
(ii) determine, from the plurality of data tables, one or more pairs of matching data tables, wherein at least one pair of two matching data tables is determined based on a comparison of row headers between the two data tables;
(iii) determine, from the plurality of data tables, one or more pairs of matching data tables, wherein at least one pair of two matching data tables is determined based on a comparison of names between the two data tables.

8. The non-transitory computer readable medium of claim 1, comprising instructions that, when executed by the one or more computers, cause the one or more computers to:
determine a matching threshold based on at least one of a number of row headers of a data table of the plurality of data tables and a number of row headers of another data table of the plurality of data tables, and determine whether said data table and said another data table match each other, based on a comparison between the row headers of said data table and row headers of said another data table, and said matching threshold.

9. The non-transitory computer readable medium of claim 1, comprising instructions that, when executed by the one or more computers, cause the one or more computers to:
for a given data table, determine whether said given data table match at least one other data table of the plurality of data tables, based on a comparison between the row headers of said data table and row headers of said other data table, wherein said comparison uses a matching threshold which is based on at least one of a number of row headers of the given data table and a number of row headers of said other data table, and
responsive to a detection that said given data table does not match any other data table of the plurality of data tables, determine whether said given data table matches at least one other data table of the plurality of data tables based on a comparison of names between the given data table and said other data table.

10. The non-transitory computer readable medium of claim 1, comprising instructions that, when executed by the one or more computers, cause the one or more computers to perform (i), (ii) or both (i) and (ii):
(i) detect a type of data stored in one or more cells of the aggregated data table, and adapt metadata of the one or more cells to this type;
(ii) the data informative of the row headers of the first data table comprise the row headers of the first data table after a processing of a format of at least some of the row headers of the first data table and the data informative of the row headers of the second data table comprise the row headers of the second data table after a processing of a format of at least some of the row headers of the second data table.

11. The non-transitory computer readable medium of claim 1, comprising instructions that, when executed by the one or more computers, cause the one or more computers to perform at least one of (i) to (iv):
(i) detect a first column and a second column of the aggregated data table which match according to a criterion, and remove the second column;
(ii) detect a first column and a second column of the aggregated data table which match according to a criterion, and remove the second column, wherein the match is detected when: (1) a column header of the first column matches a column header of the second column, and (2) for any given row which does not correspond to a row of column headers, a cell of the first column located in this given row matches a cell of the second column located in this given row, or, one of the two cells is empty;
(iii) detect a first column and a second column of the aggregated data table which match according to a criterion, and remove the second column, wherein, for any given row of the aggregated data table in which a given cell of the first column is empty, the system is configured to fill this given cell of the first column with data of a cell that was present in this given row in the second column;
(iv) detect a first column and a second column of the aggregated data table which match according to a criterion, and remove the second column, wherein, for any given row of the aggregated data table in which a given cell of the first column contains data, keep the data of this given cell of the first column.

12. The non-transitory computer readable medium of claim 1, comprising instructions that, when executed by the one or more computers, cause the one or more computers to perform at least one of (i) to (iii):
(i) detect a first row and a second row of the aggregated data table which match according to a criterion, and remove the second row;
(ii) detect a first row and a second row of the aggregated data table which match according to a criterion, and remove the second row, wherein, for any given column of the aggregated data table in which a given cell of the first row is empty, fill this given cell of the first row with data of a cell that was present in this given column in the second row;
(iii) detect a first row and a second row of the aggregated data table which match according to a criterion, and remove the second row, wherein, for any given column of the aggregated data table in which a given cell of the first row contains data, the system is configured to keep this data in the given cell of the first row.

13. The non-transitory computer readable medium of claim 1, comprising instructions that, when executed by the one or more computers, cause the one or more computers to:
when the aggregated data table comprises a first cell comprising one or more characters informative of a certain type of data and a second cell comprising data, fuse the first cell and the second cell into a cell which includes the data of the second cell, and is assigned with metadata determined based on the content of the first cell.

14. The non-transitory computer readable medium of claim 1, comprising instructions that, when executed by the one or more computers, cause the one or more computers to remove at least one of trailing white space or leading white space in one or more cells of the aggregated data table.

15. The non-transitory computer readable medium of claim 1, comprising instructions that, when executed by the one or more computers, cause the one or more computers to:
when the first data table comprises a plurality of cells arranged along first rows and first columns, and row headers, and the second data table comprises a plurality of cells arranged along second rows and second columns, and row headers, generate an aggregated data table in which the cells of the first data table are arranged as they were arranged in the first data table.

16. The non-transitory computer readable medium of claim 1, comprising instructions that, when executed by the one or more computers, cause the one or more computers to enable, in the aggregated data table, duplicate rows or duplicate columns.

17. A non-transitory computer readable medium comprising instructions that, when executed by one or more computers, cause the one or more computers to:
obtain one or more computer files storing a plurality of data tables comprising a first data table and a second data table,
wherein the first data table comprises a plurality of cells arranged along first rows associated with row headers and first columns, and
wherein the second data table comprises a plurality of cells arranged along second rows associated with row headers and second columns,
use the one or more computer files, or data generated from the one or more computer files, to generate an aggregated data table in which the cells of the first data table are arranged as they were arranged in the first data table,
wherein, for each row header of the first data table that matches another row header of the second data table, the aggregated data table comprises an aggregated row comprising cells of a row associated with said row header in the first data table and cells of a row associated with said another row header in the second data table.

18. The non-transitory computer readable medium of claim 17, comprising instructions that, when executed by the one or more computers, cause the one or more computers to perform at least one of (i) to (viii):
(i) generate the aggregated data table in which the first rows and the first columns of the first data table are arranged as they were arranged in the first data table;
(ii) perform a matching process between the row headers of the first data table and the row headers of the second data table, enabling detection of one or more matching pairs of row headers, each given matching pair of the one or more matching pairs comprising a given row header associated with a given first row of the first data table and a given row header associated with a given second row of the second data table, and use the one or more matching pairs to generate the aggregated data table in which, for each given matching pair, the aggregated data table comprises a given aggregated row comprising one or more given cells of the given first row, and one or more given cells of the given second row;
(iii) detect one or more non-matching row headers of the first data table that do not match any row headers of the second data table, and use the one or more non-matching row headers to generate one or more aggregated rows, wherein each given aggregated row of said one or more aggregated rows comprises one or more cells of a given row associated with a given non-matching row header of the one or more non-matching row headers of the first data table, and one or more empty cells, wherein a number of the one or more empty cells depends on a number of columns of the second data table;
(iv) detect one or more non-matching row headers of the second data table that do not match any row headers of the first data table, and use the one or more non-matching row headers to generate one or more aggregated rows, wherein each given aggregated row of said one or more aggregated rows comprises one or more empty cells and one or more cells of a given row associated with a given non-matching row header of the one or more non-matching row headers of the second data table, wherein a number of the one or more empty cells depends on a number of columns of the first data table;
(v) detect one or more non-matching row headers of the first data table that do not match any row headers of the second data table, and use the one or more non-matching row headers to generate one or more aggregated rows, wherein each given aggregated row of said one or more aggregated rows comprises one or more cells of a given row associated with a given non-matching row header of the one or more non-matching row headers of the first data table, followed by, in a left-to-right direction, one or more empty cells, wherein a number of the one or more empty cells depends on a number of columns of the second data table;
(vi) detect one or more non-matching row headers of the second data table that do not match any row headers of the first data table, and use the one or more non-matching row headers to generate one or more aggregated rows, wherein each given aggregated row of said one or more aggregated rows comprises one or more empty cells, followed by, in a left-to-right direction, one or more cells of a given row associated with a given non-matching row header of the one or more non-matching row headers of the second data table, and wherein a number of the one or more empty cells depends on a number of columns of the first data table;
(vii) generate a first look-up table informative of row headers of the first data table, generate a second look-up table informative of row headers of the second data table, and use the first look-up table and the second look-up table to perform an aggregation of the first data table and the second data table enabling generating the aggregated data table, wherein, during at least part of the aggregation, the first look-up table is used as a leading look-up table which dictates which row header among the row headers of the first data table is to be used for generating a next aggregated row of the aggregated data table in said aggregation;
(viii) generate a first look-up table informative of row headers of the first data table, generate a second look-up table informative of row headers of the second data table, and use the first look-up table and the second look-up table to perform an aggregation of the first data table and the second data table enabling generating the aggregated data table, wherein, during at least part of the aggregation, the first look-up table is used as a leading look-up table which dictates which row header among the row headers of the first data table is to be used for generating a next aggregated row of the aggregated data table in said aggregation, wherein, once each respective row header of the first look-up table has been used to generate a respective aggregated row of the aggregated data table, the second look-up table is selected as the leading look-up table which dictates which row header among the row headers of the second data table is to be used for generating a next aggregated row of the aggregated data table in said aggregation.

19. A non-transitory computer readable medium comprising instructions that, when executed by one or more computers, cause the one or more computers to:
obtain one or more computer files storing a plurality of data tables comprising a first data table and a second data table, wherein the first data table comprises a plurality of first columns associated with column headers, and the second data table comprises a plurality of second columns associated with column headers,
use the one or more computer files, or data generated from the one or more computer files, to perform an aggregation of the first data table and of the second data table into an aggregated data table comprising aggregated columns, wherein said aggregation comprises:
selecting the first data table, or data informative thereof, as a leading data table which dictates which column header among the column headers of the first data table is used for generating a next aggregated column of the aggregated data table in said aggregation, and,
responsive to an event, selecting the second data table as the leading data table which dictates which column header among the column headers of the second data table is used for generating the next aggregated column of the aggregated data table in said aggregation.

20. The non-transitory computer readable medium of claim 19, comprising instructions that, when executed by the one or more computers, cause the one or more computers to perform at least one of (i) to (vi):
(i) said event corresponds to detecting that a first column header of the first data table, among the column headers of the first data table that correspond to columns that have not yet been inserted in the aggregated data table, does not match a first column header of the second data table, among the column headers of the second data table that correspond to columns that have not yet been inserted in the aggregated data table;
(ii) for a column header of a column of the first data table that has been identified as matching a column header of a column of the second data table, the aggregated data table comprises an aggregated column comprising cells of said column of the first data table and cells of said column of said column of the second data table;
(iii) for a column header of a column of the first data table that has been identified as not matching any column header of the second data table, the aggregated data table comprises an aggregated column comprising cells of said column of the first data table followed by, in a top-to-down direction, empty cells;
(iv) for a column header of a column of the second data table that has been identified as not matching any column header of the first data table, the aggregated data table comprises an aggregated column comprising empty cells followed by, in a top-to-down direction, cells of said column of the second data table.
(v) perform an aggregation of the first data table and of the second data table to generate the aggregated data table, wherein, in said aggregation, generating of a next aggregated column depends on a selection of a first look-up table or of a second look-up table as a leading look-up table which dictates which column header among the column headers of the first data table or of the second data table is used for generating the next aggregated column, wherein the data generated from the one or more computer files comprises the first look-up table informative of the row headers of the first data table and the second look-up table informative of the row headers of the second data table;
(vi) perform an aggregation of the first data table and of the second data table to generate the aggregated data table, wherein, in said aggregation, generating of a next aggregated column depends on a selection of a first look-up table or of a second look-up table as a leading look-up table which dictates which column header among the column headers of the first data table or of the second data table is used for generating the next aggregated column, wherein the data generated from the one or more computer files comprises the first look-up table informative of the row headers of the first data table and the second look-up table informative of the row headers of the second data table, wherein, when the first look-up table has been selected as the leading look-up table, compare a first column header of the first look-up table with a first column header of the second look-up table, and responsive to detecting that the first column header of the first look-up table does not match the first column header of the second look-up table, generate a command for selecting the second look-up table as the leading look-up table.
